(19) United States
(12) Patent Application Publication
(10) Pub. No.: US 2012/0066010 A1
(43) Pub. Date: Mar. 15, 2012

(54) VEHICLE REPAIR SYSTEM

(76) Inventors: Robert Williams, Clovis, CA (US); Sandra W. Medeiros, Fresno, CA (US); Milton A. Medeiros, Fresno, CA (US)

(21) Appl. No.: 13/233,862

(22) Filed: Sep. 15, 2011

Related U.S. Application Data
(60) Provisional application No. 61/382,999, filed on Sep. 15, 2010.

(51) Int. Cl. G06Q 30/06; G06Q 40/08; G06Q 10/06; G06Q 10/00

(52) U.S. Cl. 705/4; 705/305; 705/27.1; 705/7.27

(57) ABSTRACT

A vehicle repair system facilitates communication between multiple parties involved in the repair of a vehicle. A status engine monitors the status of a vehicle repair and provides status information to a customer so the customer can stay up-to-date on the current status. A store engine provides a marketplace where vehicle repair products can be sold. A jobs engine provides a jobs board where job openings can be posted.

### CROSS-REFERENCE TO RELATED APPLICATION

This application claims priority to U.S. Ser. No. 61/382,999 filed on Sep. 15, 2010, titled VEHICLE REPAIR SYSTEM, the entire disclosure of which is hereby incorporated by reference.

### INTRODUCTION

When a vehicle needs repair, it is often brought to a commercial repair site where skilled repair personnel can return the vehicle to proper operating condition. Repair sites include body shops that often work on a vehicle that has been involved in a collision, and service centers that often perform routine maintenance on vehicles as well as repair vehicles that have broken down or are otherwise underperforming.

In order for a repair site to have satisfied customers, it is crucial for the repair site to maintain good communication with the customer. Since many repairs require several hours or even days to be completed, the customer is often not present at the repair site during the repair, and so face to face communication is not possible. Most often, telephone calls are used to communicate with the customer.

Unfortunately, telephone calls are often inadequate to maintain good communication with a customer. Telephone calls are often not properly timed, for example, and may result in each party trading voicemail messages with the other. In addition, frequent telephone calls are time consuming, and are therefore repair site personnel often wait to make such calls until important information needs to be communicated (such as to request authorization of a repair order or inform the customer that the repair has been completed). This results in periods of time in which the customer is unaware of the status of the repair, and may lead to frustration if the customer's expectations are not in line with the actual repair process.

There is a need in the art for systems and methods for facilitating communication between two or more parties involved in a repair.

### SUMMARY

In general terms, this disclosure is directed to a vehicle repair system. In one possible configuration and by non-limiting example, the vehicle repair system communicates digital data across a data communication network to facilitate communication between two or more parties involved with a vehicle repair, such as between a customer, a repair site, an insurance company, a rental car company, and others.

One aspect is a method of obtaining customer authorization for a vehicle repair, the method comprising: storing, with a computing device, a supplemental estimate document in a data storage device, the supplemental estimate describing a supplemental repair for which customer approval has not been obtained; generating and sending a supplemental repair message to the customer informing the customer of a need for the supplemental repair; and receiving an authorization message from the customer authorizing the supplemental repair.

Another aspect is a system comprising at least one processor device and at least one computer readable storage medium storing data instructions thereon, the system further comprising: a status engine operable by the at least one processor upon execution of the data instructions to maintain a record of a project at a company and to provide status information from the record to customers of the company showing the statuses of the projects; a store engine operable to generate a marketplace for sales of products associated with the company, wherein products at the company are listed for sale by the store engine and products needed by the company are available for purchase through the store engine; and a jobs engine providing a jobs board that receives job information from the company and transmits that information to prospective employees of the company

Yet another aspect is a vehicle repair system, the vehicle repair system comprising at least one processor device and at least one computer readable storage medium storing data instructions thereon, the vehicle repair system further comprising: a status engine operable by the at least one processor upon execution of the data instructions to maintain a record of vehicle repairs at a vehicle repair site and to provide status information from the record to customers of the vehicle repair site showing the statuses of the vehicle repairs; a store engine operable to generate a marketplace for sales of products associated with vehicle repairs, wherein products at the vehicle repair site are listed for sale by the store engine and products needed by the vehicle repair site are available for purchase through the store engine; and a jobs engine providing a jobs board that receives job information from the vehicle repair site and transmits that information to prospective employees of the vehicle repair site.

A further aspect is a vehicle repair system comprising at least one processing device and at least one computer readable storage media, the at least one computer readable storage media storing program instructions that when executed by the at least one processing device generate: a status engine operable by the at least one processing device to receive status information from one or more vehicle repair site users describing a status of a vehicle being repaired at the vehicle repair site, and to provide the status information to a customer associated with the vehicle, wherein the status information is provided through one or more web pages, at least one of the web pages including a summary status display, wherein the summary status display identifies at least a delay status and a supplemental repair status, wherein the delay status identifies whether the repair is currently delayed, and wherein the supplemental repair status identifies whether any additional work has been identified for which the customer's approval is required

### BRIEF DESCRIPTION OF THE DRAWINGS

FIG. 1 is a schematic block diagram of an example vehicle repair network.

FIG. 2 illustrates an exemplary architecture of a computing device of the vehicle repair network shown in FIG. 1.

FIG. 3 is a schematic block diagram of an example vehicle repair system.

FIG. 4 is a screen shot of an example home page of the vehicle repair system shown in FIG. 3.

FIG. 5 is a schematic block diagram of an example status engine of the vehicle repair system shown in FIG. 3.

FIG. 6 is a screen shot of an example customer home page.

FIG. 7 is a screen shot of an example detailed vehicle status page of a customer interface engine.

FIG. 8 is a screen shot of an example supplemental repair approval page.

FIG. 9 is a screen shot of an example repair site home page.

FIG. 10 is a screen shot of a portion of an example detailed vehicle status page of a repair site interface engine.

FIG. 11 is a screen shot of an example supplemental repair message page.

FIG. 12 is a screen shot of an example login page displayed on a mobile computing device.

FIG. 13 is a screen shot of an example home page displayed on the mobile computing device.

FIG. 14 is a screen shot of an example supplement information page displayed on the mobile computing device.

FIG. 15 is a screen shot of an example pictures page displayed on the mobile computing device.

FIG. 16 is a screen shot of an example messages page displayed on the mobile computing device.

FIG. 17 is a schematic block diagram of an example store engine.

FIG. 18 is a screen shot of an example home page generated by a centralized store interface engine.

FIG. 19 is a screen shot of an example item display page provided by the centralized store interface engine.

FIG. 20 is a screen shot of an example customized repair site home page, such as generated by a customized repair site store interface engine.

FIG. 21 is a screen shot of an example mobile home page provided by the customized repair site store interface engine.

FIG. 22 is a screen shot of an example featured products page displayed on a mobile computing device.

FIG. 23 is a screen shot of an example item details page displayed on the mobile computing device.

FIG. 24 is a screen shot of an example jobs home page generated by a jobs engine.

FIG. 25 is a screen shot of an example job detail page.

FIG. 26 is a screen shot of an example job posting page.

FIG. 27 is a screen shot of an example mobile latest listings page displayed on the mobile computing device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

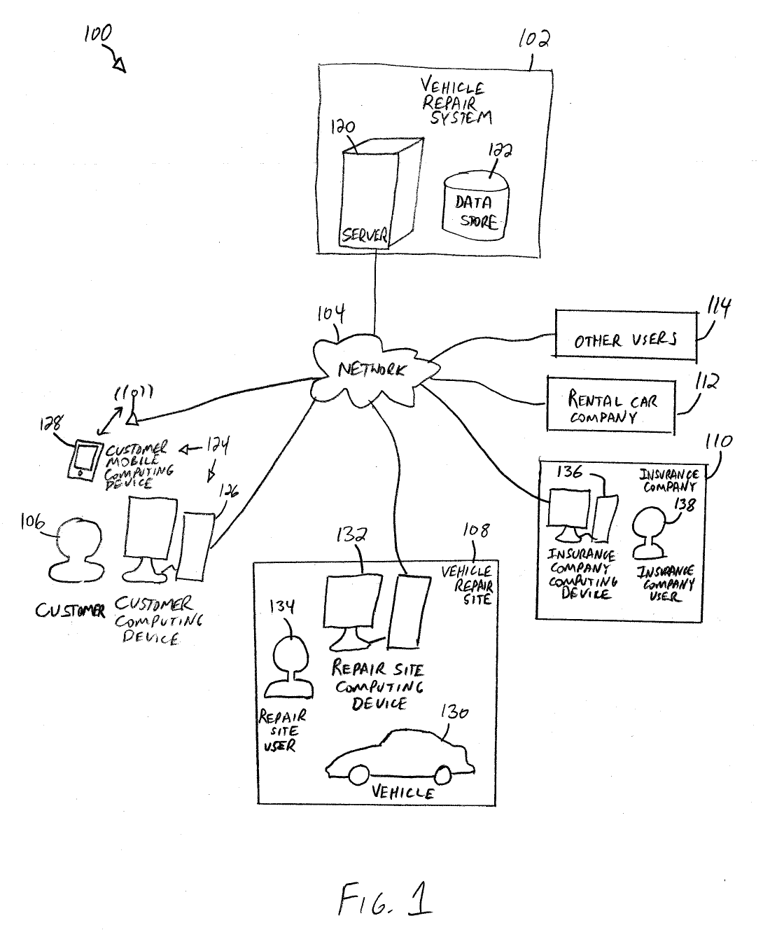

FIG. 1 is a schematic block diagram of an example vehicle repair network 100. In this example, the vehicle repair network 100 includes a vehicle repair system 102 configured to communicate across a data communication network 104 with multiple parties. The parties include two or more of, for example, a customer A, a vehicle repair site 108, an insurance company 110, a rental car company 112, and others 114.

Vehicle repair network 100 facilitates communication between two or more parties involved in a vehicle repair. For example, the customer 106 can utilize the vehicle repair network 100 to check on the status of the vehicle repair. The vehicle repair site 108 can utilize the vehicle repair network 100 to provide status updates to the customer 106. The insurance company 110 can utilize the vehicle repair network 100 to review and approve claims, view photos or video showing the damage, and confirm that the repair was completed. Other embodiments perform one or more alternative or additional functions, as described in more detail herein.

The vehicle repair network 100 includes vehicle repair system 102, including at least one server computing device 120 and at least one data storage device 122. Some embodiments include two or more server computing devices 120 and can also include two or more data storage devices 122. In some embodiments, the data storage device 122 is part of the one or more server computing devices 120. In other embodiments, the data storage device includes one or more separate computing devices. The vehicle repair system 102 can be at a single location, or distributed across multiple locations, utilizing data communication across data communication network 104, for example.

The data communication network 104 permits digital data to be communicated between computing devices. An example of a data communication network 104 is the Internet. The data communication network 104 can include multiple communication networks that collectively perform the data communication. Examples of such networks include the Internet, a local area network, a wireless or cellular communication network, and the like.

The customer 106 interacts with the vehicle repair system 102 using one or more customer computing devices 124. Examples of customer computing devices 124 include a desktop computing device 126 and a mobile computing device 128. The desktop computing device 126 is, for example, a personal computer. The mobile computing device 128 is, for example, a smartphone, a laptop computer, a personal digital assistant, a tablet computer, and the like. Two popular examples of mobile computing devices 128 include the iPhone® and the iPad® available from Apple Inc. of Cupertino, Calif. Other mobile computing devices are available from HTC Corporation of Taiwan, Research in Motion of Ontario, Canada, etc. Vehicle repair network 100 typically includes many different customers 106.

The vehicle repair site 108 provides vehicle repair services. In this example, the vehicle 130 belonging to customer 106 is at the vehicle repair site 108 for repair. In addition to vehicle repair tools and personnel, the vehicle repair site 108 includes a repair site computing device 132 that can be used by one or more users 134 to interact with the vehicle repair system 102. Some embodiments of the vehicle repair network 100 include multiple vehicle repair sites 108.

The insurance company 110 provides insurance services. In this example, the customer 106 has an insurance policy on the vehicle 130 with the insurance company 110. As a result, the insurance company 110, if the claim is approved, pays for at least a portion of the vehicle repair performed by the vehicle repair site 108.

The insurance company 110 includes an insurance company computing device 136 that can be used by an insurance company user 138 to interact with the vehicle repair system 102. Some embodiments of the vehicle repair network 100 include multiple insurance companies 110.

A rental car company 112 can similarly interact with the vehicle repair system 102. The rental car company 110 provides a rental car to the customer 106 while the repair is being completed. The rental car company 112 can utilize the vehicle repair system 102 to monitor the status of the repair, for example, so that it can predict when the rental car will be available for use by another customer. The rental car company 112 can interact with the vehicle repair system 102 through one or more computing devices. Some embodiments of the vehicle repair network 100 include multiple insurance companies 110.

Other users 114 or other third-parties can also interact with the vehicle repair system 102 in some embodiments. For example, in some embodiments a person seeking a job with a vehicle repair site 108 can look for job opportunities. As another example, third-party social networking sites can interact with the vehicle repair system 102.

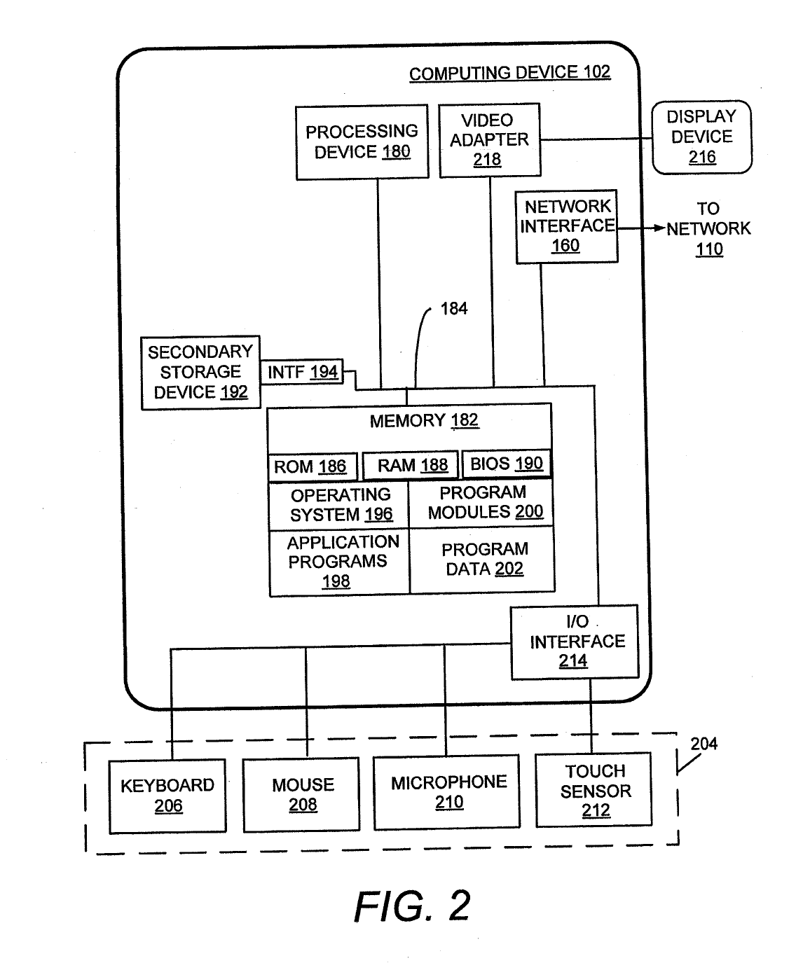

FIG. 2 illustrates an exemplary architecture of a computing device that can be used to implement aspects of the present disclosure, including the server computing device 120 or any of the plurality of computing devices 124 (including 126 or 128), 132, 136, or any other computing device described herein. The computing device illustrated in FIG. 2 can be used to execute the operating system, application programs, and software modules (including the software engines) described herein. By way of example, the computing device will be described below as the server computing device 120. To avoid undue repetition, this description of the computing device will not be separately repeated herein for each of the other computing devices, including computing devices 124, 126, 128, 132, and 136, but such devices can also be configured as illustrated and described with reference to FIG. 2.

The computing device 120 includes, in some embodiments, at least one processing device 180, such as a central processing unit (CPU). A variety of processing devices are available from a variety of manufacturers, for example, Intel or Advanced Micro Devices. In this example, the computing device 120 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices include a desktop computer, a laptop computer, a tablet computer, a mobile device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 120, such as during start up, is typically stored in the read only memory 186.

The computing device 120 also includes a secondary storage device 192 in some embodiments, such as a hard disk drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 120.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 192 or memory 182, including an operating system 196, one or more application programs 198, other program modules 200 (such as the software engines described herein), and program data 202.

In some embodiments, a user provides inputs to the computing device 120 through one or more input devices 204. Examples of input devices 204 include a keyboard 206, mouse 208, microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch screen display device, is also connected to the system bus 184 via an interface, such as a video adapter 218. In addition to the display device 216, the computing device 120 can include various other peripheral devices (not shown), such as speakers or a printer.

When used in a local area networking environment or a wide area networking environment (such as the Internet), the computing device 120 is typically connected to the network 104 through a network interface, such as an Ethernet interface 160. Other possible embodiments use other communication devices. For example, some embodiments of the computing device 120 include a modem for communicating across the network.

The computing device 120 typically includes at least some form of computer-readable media. Computer readable media includes any available media that can be accessed by the computing device 120. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 120.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

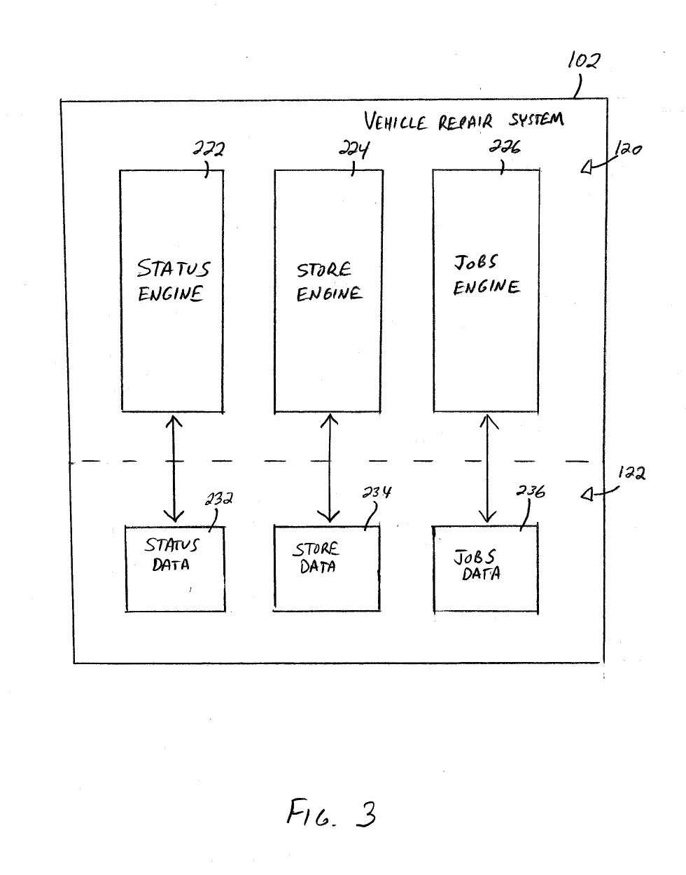

FIG. 3 is a schematic block diagram illustrating an example of the vehicle repair system 102. In some embodiments, the vehicle repair system 102 includes one or more engines operated by one or more server computing devices 120, such as a status engine 222, store engine 224, and jobs engine 226. The vehicle repair system 102 further includes one or more data storage devices 122 storing data thereon. The data includes, for example, status data 232, store data 234, and jobs data 236.

In some embodiments, vehicle repair system 102 is a web server 120 that communicates across data communication network 104 using standard data communication protocols. In some embodiments, the web server 120 sends web page data using according to the hypertext transfer protocol (HTTP) responsive to requests received from a client computing device, such as the customer computing device 124, the repair site computing device 132, and the insurance company computing device 136. The web page data can be transferred to the client computing device using hypertext markup language (HTML), for example. The client computing device runs a browser software application that reads the HTML and presents the web page to the user. In some embodiments, the vehicle repair system 102 utilizes cloud computing.

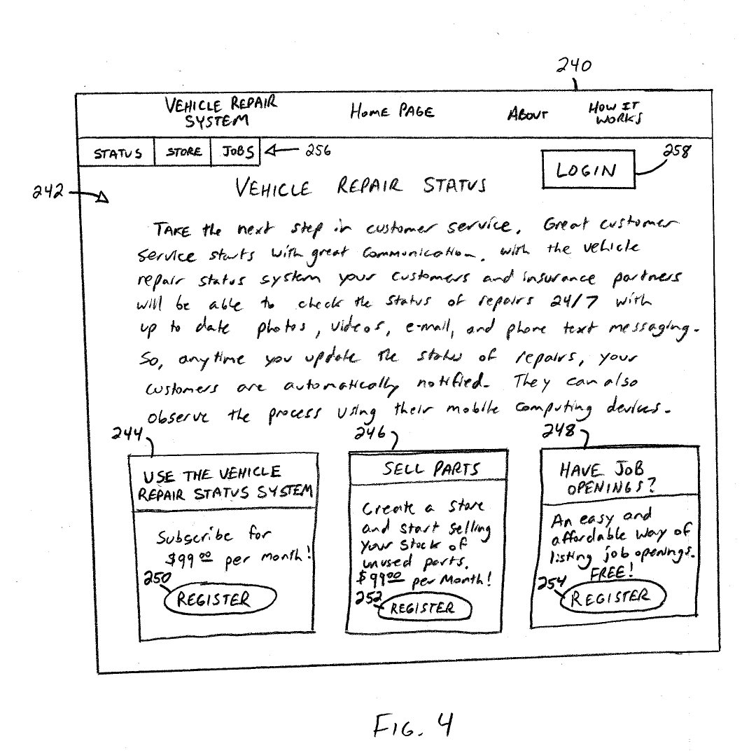

The status engine 222 tracks the status and history of vehicle repairs. The status engine 222 saves and retrieves status data 232 in and from data storage device 122. The status engine is illustrated and described in more detail herein with reference to FIGS. 4-17.

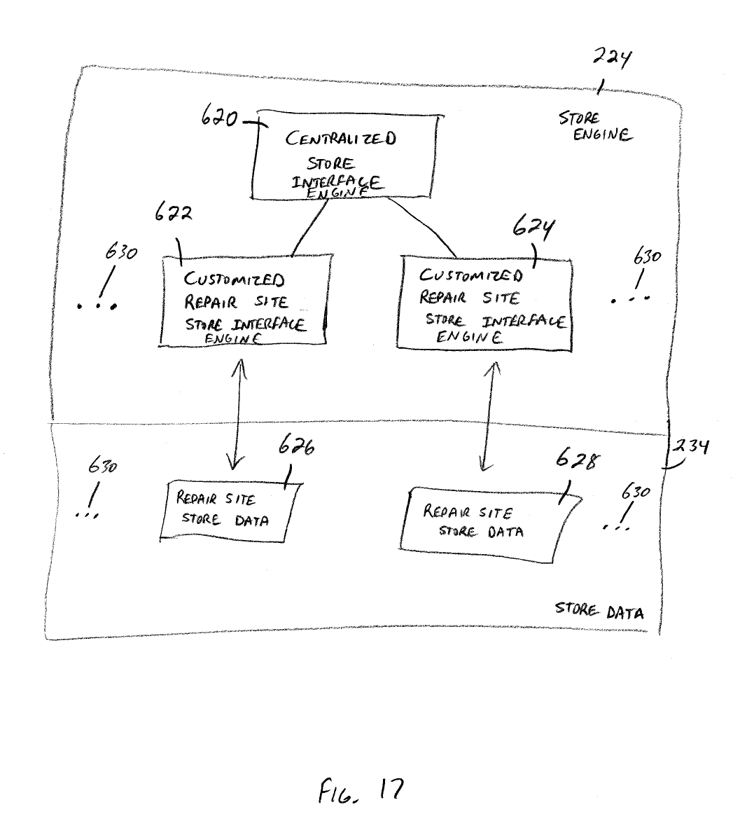

The store engine 224 provides a marketplace advertising products that are for sale relating to vehicle repair, and for locating such products. The store engine 224 saves and retrieves store data 234 in and from data storage device 122. The store engine 224 is illustrated and described in more detail herein with reference to FIGS. 17-23.

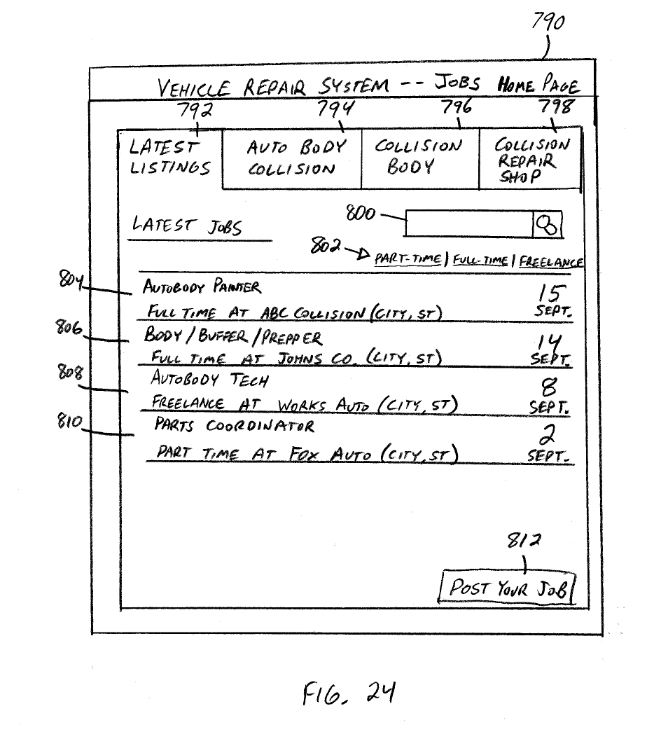

The jobs engine 226 provides a job board where vehicle repair sites can post job openings and where people seeking employment at a vehicle repair site can search for job openings. The jobs engine 226 saves and retrieves jobs data 236 in and from data storage device 122. The jobs engine 226 is illustrated and described in more detail with reference to FIGS. 24-27.

Additional (or less) data may be stored in vehicle repair system 102, such as described herein.

FIG. 4 is a screen shot of an example home page 240 of the vehicle repair system 102, as displayed at the client computing device 126. The customer home page 240 acts as the gateway to the vehicle repair system for new or returning users to access the various aspects of the system 102.

In this example, the home page includes introductory information section 242, registration windows 244, 246, and 248, links bar 256, and login control 258.

The information section 242 provides information about aspects of the vehicle repair system 102, such as about the vehicle repair status features. The information may include a narrative text-based description, one or more photographs, one or more videos, or other graphics or animation.

The registration windows 244, 246, and 248 provide information for vehicle repair sites about some of the features available through the vehicle repair system. For example, registration window 244 provides information about the vehicle repair status system, and includes a registration control 250 that can be selected by a vehicle repair site user to register the vehicle repair site to utilize that feature. Similarly, registration windows 246 and 248 provide information about the store and jobs features, and provide controls 252 and 254 that can be selected to register the vehicle repair site to utilize the respective features.

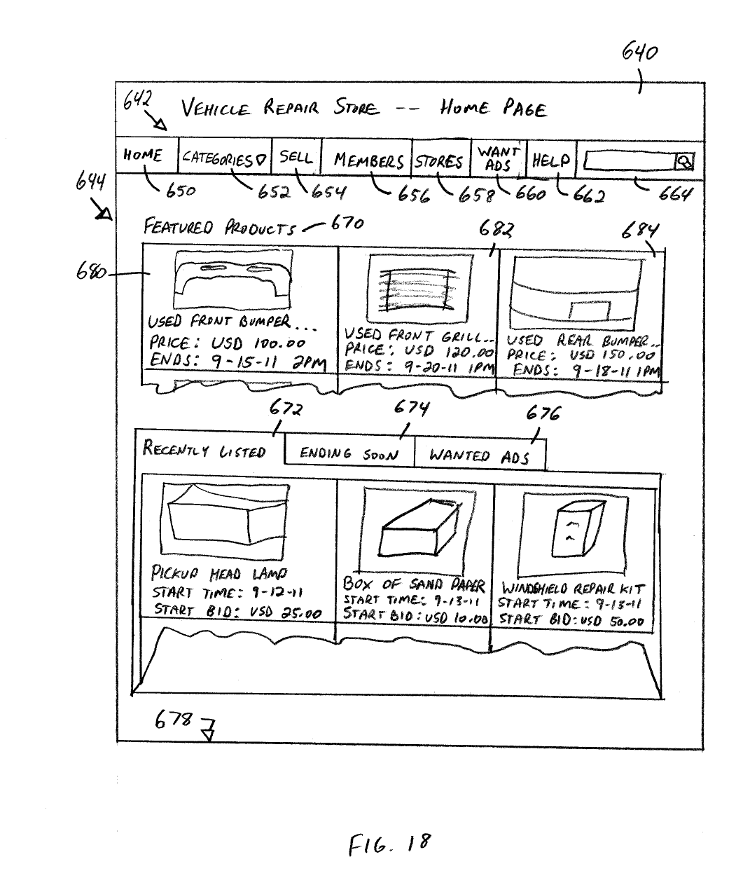

After selecting one of the registration controls 250, 252, or 254, a registration process prompts the user to provide additional information. The information includes, for example, a username and password, a business name, a business address, a business telephone number, and payment information (such as a credit card number). This information is then stored in the data storage device 122. The vehicle repair system 102 then displays the repair site status home page 430, the store home page 640 (shown in FIG. 18), or the jobs home page 790 (shown in FIG. 24).

The links bar 256 includes controls that can be selected by the user to jump to a different portion of the site. In this example, the links bar 256 includes a control linked to the status home page 240, a control linked to the store home page 640 (shown in FIG. 18), and the jobs home page 790 (shown in FIG. 24). Selection of the control causes the vehicle repair system to advance to the selected page.

The login control 258 is provided for registered users to login to the vehicle repair system 102. Upon selection, the user is prompted for login credentials, such as a username and password, or a vehicle identification number and a repair order, or other suitable credentials. This information is compared with data stored in the data storage device 122, and if validated, the user is permitted to proceed with the vehicle repair system 102.

The home page 240, in this example, acts as both the home page for the vehicle repair system 102, as well as the home page for the vehicle repair status portion of the system, operated by the status engine 222 (shown in FIG. 3). Accordingly, after logging in, the user interface of the vehicle repair status system is displayed.

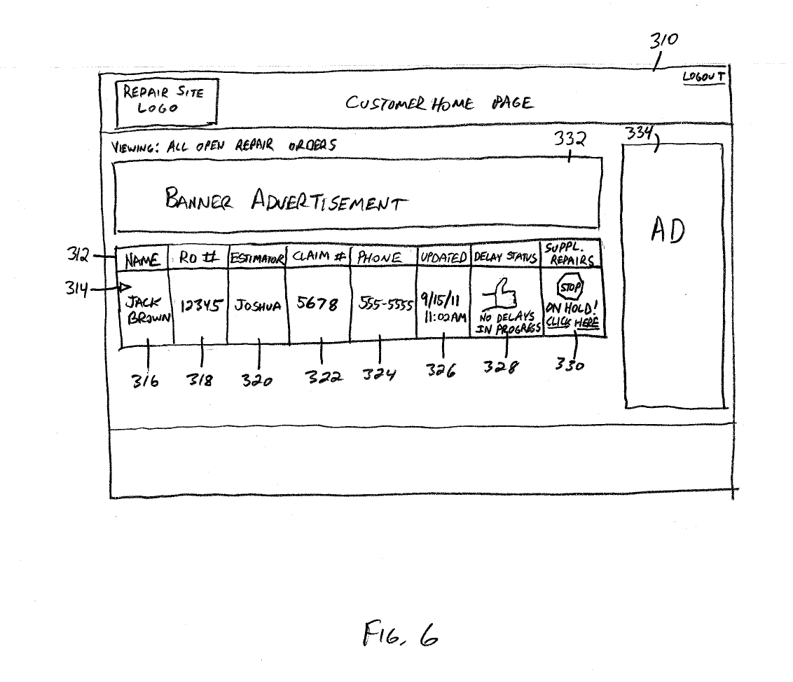

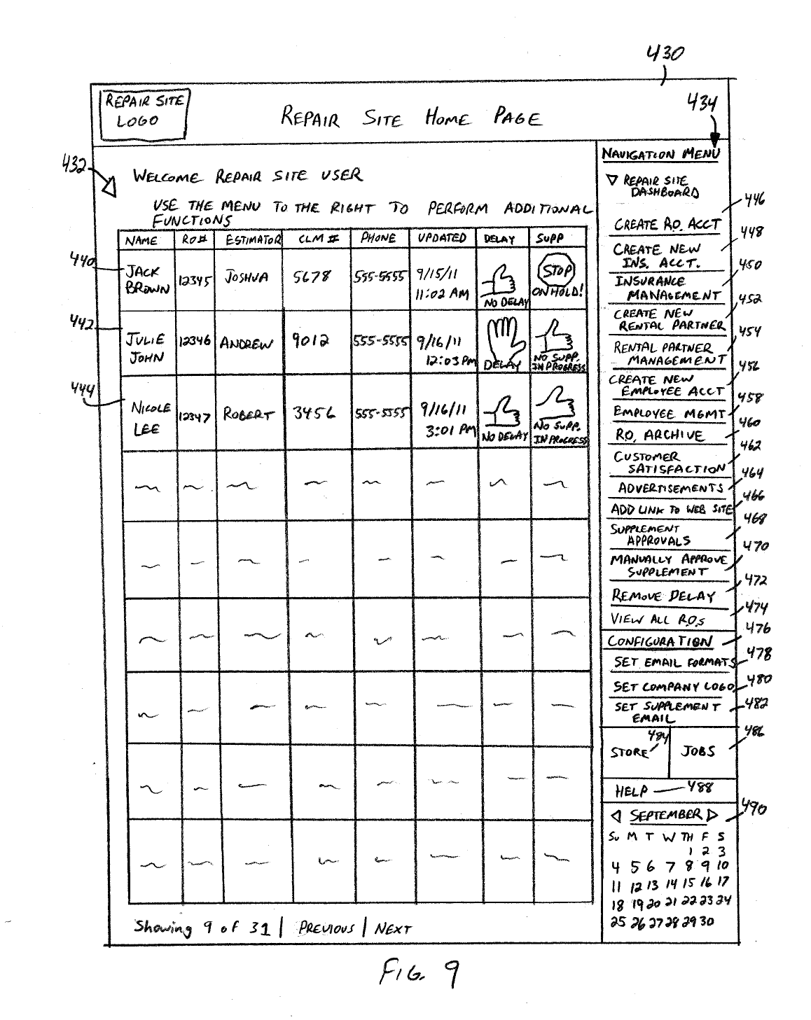

During the login process, the vehicle repair system 102 determines the user type that the user is registered as. If the user is registered as a customer 106, the customer home page 310 is displayed after login, as shown in FIG. 6. If the user is registered as a vehicle repair site user 134, the repair site home page 430 is displayed, as shown in FIG. 9. If the user is registered as an insurance company user 138, the insurance company home page is displayed. If the user is registered as a rental car company 112 user, the rental company home page is displayed. Similarly, additional home pages are provided in some embodiments for other user types.

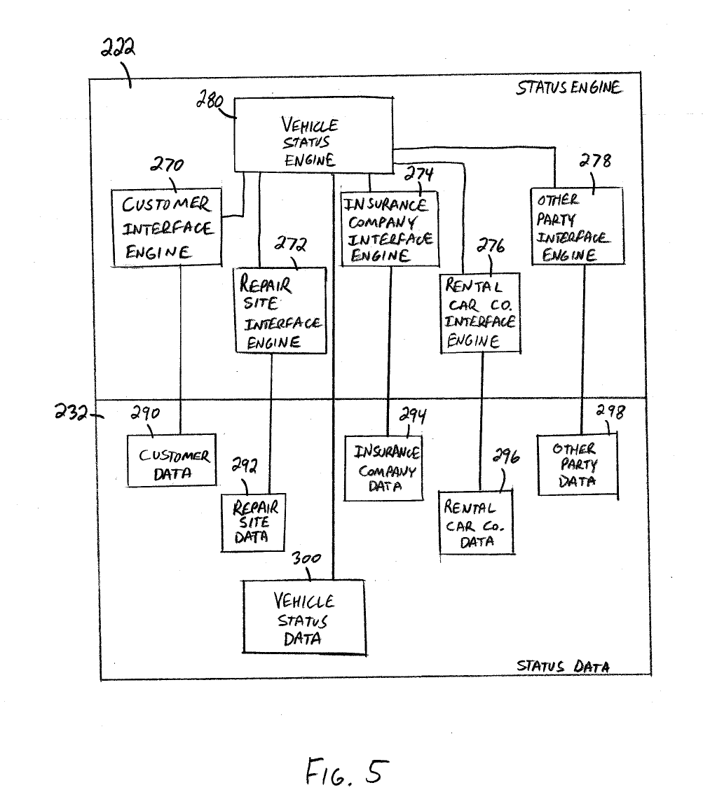

FIG. 5 is a schematic block diagram illustrating examples of the status engine 222 and the status data 232 (as shown in FIG. 3). In this example, the status engine 222 includes customer interface engine 270, repair site interface engine 272, insurance company interface engine 274, rental car company interface engine 276, other party interface engine 278, and vehicle status engine 280. The status data includes customer data 290, repair site data 292, insurance company data 294, rental car company data 296, other party data 298, and vehicle status data 300.

The customer interface engine 270 operates to interact with the customer 106 (FIG. 1) through the customer computing device 124. For example, the customer interface engine 270 generates user interfaces, receives input from, and performs the processing necessary to interact with the customer computing device. The customer interface engine 270 utilizes and stores data in customer data 290. An example of the customer interface engine 270 is illustrated and described in more detail herein with reference to FIGS. 6-8.

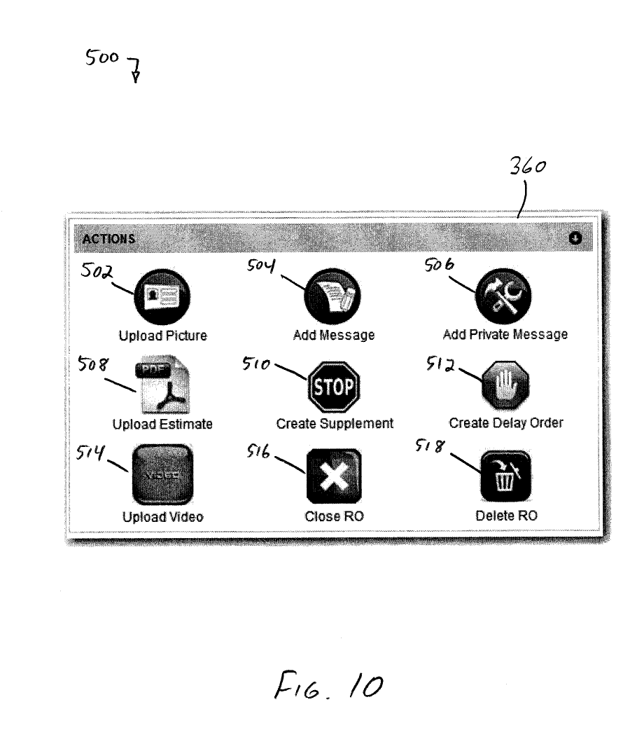

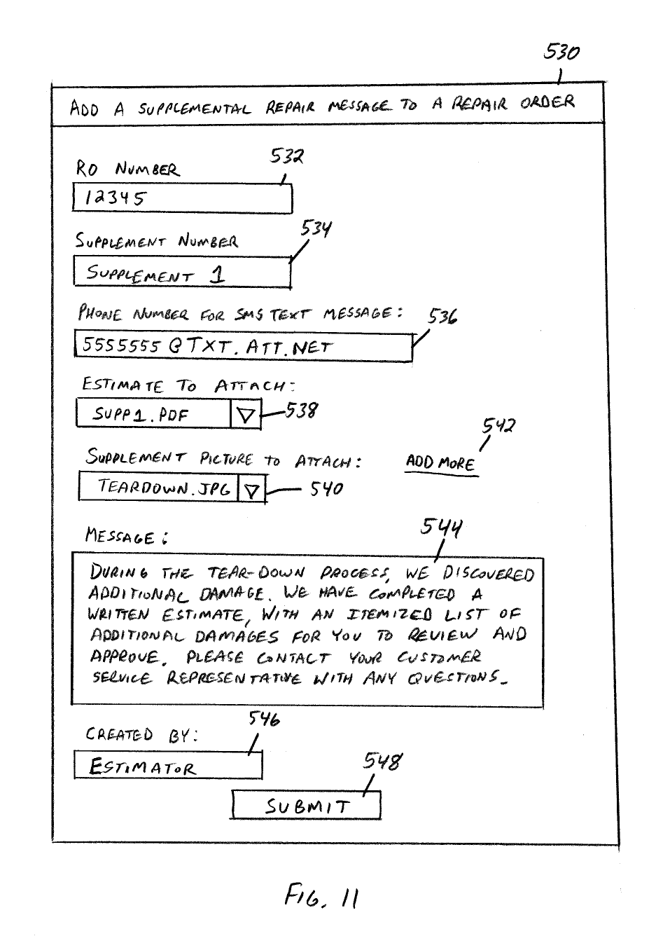

The repair site interface engine 272 operates to interact with the repair site user 134 (FIG. 1) through the repair site computing device 132. For example, the repair site interface engine 272 generates user interfaces, receives input from, and performs the processing necessary to interact with the repair site computing device 132. The repair site interface engine 272 utilizes and stores data in repair site data 292. An example of the repair site interface engine 272 is illustrated and described in more detail herein with reference to FIGS. 10-11.

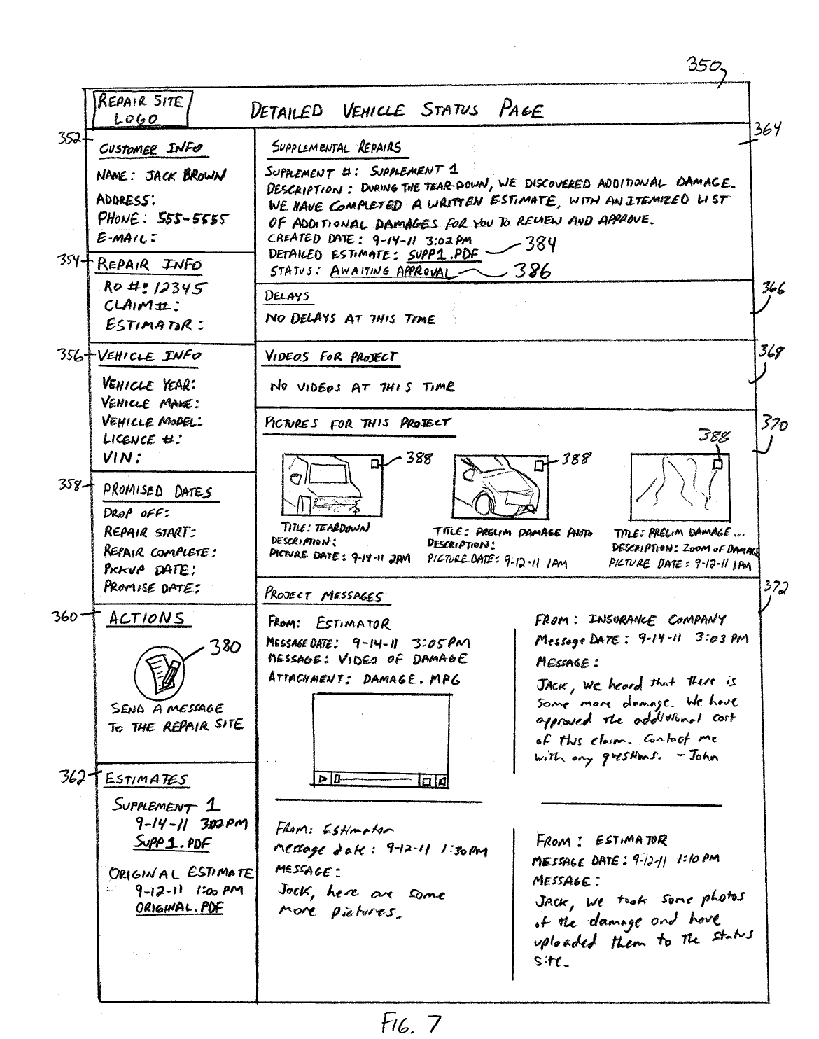

The insurance company interface engine 274 operates to interact with the insurance company user 138 (FIG. 1) through the insurance company computing device 136. For example, the insurance company interface engine 274 generates user interfaces, receives input from, and performs the processing necessary to interact with the insurance company computing device 136. The insurance company interface engine 274 utilizes and stores data in insurance company data 294. The insurance company interface engine 274 operates similar to the customer interface engine 270 and the repair site interface engine 272, as described herein. For example, the insurance company user 138 is prompted to login, such as by selecting the name of the insurance company from a drop-down list, and entering the password associated with that company account. The system then prompts the insurance company user 138 to enter a claim number. If the claim number matches a repair order in the system, and the insurance company is identified as the insurance company associated with the repair order, then the insurance company interface engine 274 generates the detailed vehicle status page for the repair order, similar to the customer version shown in FIG. 7. The insurance company can then review the status of the vehicle repair, and can send and receive messages and private messages, as desired.

The rental car company interface engine 276 operates to interact with the rental company user through the rental company computing device. For example, the rental car company interface engine 276 gen generates user interfaces, receives input from, and performs the processing necessary to interact with the rental company computing device. The rental company interface engine 276 utilizes and stores data in rental car company data 296. The rental company interface engine 276 operates in a similar manner to the insurance company interface engine 274, described herein, to permit the rental car user to review the status of a vehicle repair, and to send and receive messages and private messages, as desired.

Additional users or companies can similarly interact with the vehicle repair system through one or more other party interface engines 278, if desired. The data is stored and retrieved from other party data 298.

The vehicle status engine 280 performs the processing necessary to keep track of the statuses of vehicles 130 (FIG. 1) at one or more vehicle repair sites 108. The data is stored and retrieved from vehicle status data 300. The vehicle status engine 280 cooperates with the interface engines 270, 272, 274, 276, and 278 to permit the interface engines 270, 272, 274, 276, and 278 to display or modify vehicle status data 300. In some embodiments, the operations of the vehicle status engine are performed by each of the interface engines themselves, such that a separate vehicle status engine may not be included in all embodiments.

In various embodiments, the status engine 222 includes one or more of the interface engines illustrated and described in FIG. 5, such that each of the interface engines are not required in all embodiments. Similarly, the status data 232 need not include all of the data illustrated in FIG. 5.

FIGS. 6-8 illustrate the operation of an example customer interface engine 270, shown in FIG. 5. The customer interface engine 270 operates to interact with customers 106 whose vehicles 130 are being, or have been, repaired by one or more vehicle repair sites 108 utilizing the status engine 222 (FIG. 5) of the vehicle repair system 102 (FIG. 1). The examples show the interaction with a customer that has already been registered with the status engine 222, such that the customer's information is already stored in customer data 290 (FIG. 5). The registration of a customer is illustrated and described herein with reference to the repair site interface engine 272.

FIG. 6 is a screen shot of an example customer home page 310 of the customer interface engine 270. The customer home page 310 is displayed to the customer 106 on the customer computing device 124 (FIG. 1), after the customer has logged in to the vehicle repair system 102. To login, the customer provides identifying information, such as a username and password, or a vehicle identification number and repair order number, or other information.

In this example, the customer home page 310 displays a list 312 of one or more open repair orders. A repair order is typically associated with a single vehicle 130 (FIG. 1). A single repair order may be associated with multiple repairs, if the repairs are all being performed on the vehicle 130 during a repair session. Advertisements 332 and 334 are included in some embodiments.

The list 312 includes a status summary display 314 for each repair order in the list. In this example, the status summary display 314 displays information associated with the repair order, such as the customer name 316, repair order number 318, name of repair site estimator 320 (the person at the repair site 108 assigned to provide estimates to the customer 106 for all repairs), claim number 322 (for insurance company), customer phone number 324 (or other contact information), time of last update 326, delay status 328, and supplemental repair status display 330.

The status summary display 314 therefore provides the customer 106 with a summary display that permits the customer 106 to quickly and easily determine the status of the vehicle repair. For example, the time of last update 326 shows the customer 106 when the status information for the repair was last updated, so that the customer 106 can determine whether anything has changed since the time the repair order was first entered, or whether anything has changed since the last time the customer 106 logged into the vehicle repair system 102 to review the status of the repair order.

In addition, in some embodiments the status summary display 314 is selectable to provide additional information about the repair order. For example, after receipt of a selection of the status summary display 314, the detailed vehicle status page 350 is displayed, as shown in FIG. 7.

The delay status 328 indicates whether the current repair is proceeding according to schedule, or whether there are any actions that have unexpectedly delayed the repair. In some embodiments, the delay status 328 includes a graphical element that graphically depicts the status. In this example, the graphical element is a representation of a hand with the thumb pointing up, indicating that everything is okay. Other graphical elements can include, for example, a stop sign indicating that something has delayed the repair. Other graphical elements can also or alternatively be used, such as background colors (e.g., red, yellow, and green), different fonts, different font types, animations, etc.

In some embodiments, the delay status 328 also or alternatively includes a text description of the status. In this example, the delay status 328 indicates that there are no delays and that the repair is in progress. Other descriptions can include, for example, “delayed,” “repair completed,” “customer input required,” “part needed,” “waiting for part,” or other suitable descriptions.

The supplemental repair status display 330 indicates whether any modifications to the original estimate are required, and if so, indicates that customer approval is required before the repair can proceed, in some embodiments. This prevents any charges from being made in excess of the original written estimate without authorization from the customer. A supplemental repair is, for example, any difference between an original estimate and the repairs that are required. In order to ensure that no repairs are made without the customer being informed and consenting to the repair, a supplemental repair order approval can be required. The supplemental repair order includes a line-item detail estimate for the supplemental repair, including a description of the repair to be completed, as well as a detailed cost estimate for each portion of the supplemental repair (parts, labor, etc.). In some embodiments, once a supplemental repair is determined to be necessary by the repair site 108, the supplemental repairs are put on hold pending approval by the customer 106. The supplemental repair order request and approval process is illustrated and described in more detail herein. If no supplemental repairs are required, or the supplemental repairs have been approved, the supplemental repair status display 330 indicates that the repair is proceeding and that no, or no additional, supplemental repairs are required. In some embodiments, the supplemental repair status display 330 include a graphical element and a text description.

Customer information (including at least customer name 316 and phone 324) displayed in the customer home page 310 is retrieved from customer data 290, shown in FIG. 5. Vehicle status information (including at least time last updated 326, delay status 328, and supplemental repair status display 330) is retrieved from vehicle status data 300. Additional information is similarly retrieved from status data 232 as desired.

FIG. 7 is a screen shot of an example detailed vehicle status page 350, such as generated by the customer interface engine 270 (FIG. 5) upon selection of the status summary display 314 (shown in FIG. 6) for a particular repair order. The detailed vehicle status page 350 presents additional information about the status of the vehicle repair.

The detailed vehicle status page 350 presents additional information to the customer 106 regarding the status of the vehicle 130 repair, as well as providing additional tools that the customer 106 can use to interact with other users during the vehicle repair process.

In this example, the detailed vehicle status page 350 includes a first column including customer information display 352, repair information display 354, vehicle information display 356, promised dates display 358, actions display 360, and estimates display 362; and a second column including supplemental repairs display 364, delays display 366, videos display 368, pictures display 370, and project messages display 372. The specific two-column layout is only one possible example, and other embodiments can include different layouts. In addition, the detailed vehicle status page 350 can alternatively be formed of multiple pages. In yet other embodiments, the detailed vehicle status page 350 can include more, less, or different information than shown in FIG. 7.

The customer information display 352 includes information about customer 106, such as the name, address, telephone number, and e-mail address currently on file for this customer. This information is displayed to permit the customer 106 to verify that the information is correct and current, and to notify the repair site if any information needs to be updated. In some embodiments, the customer can edit the customer 106 information directly.

The repair information display 354 includes information about the repair, such as the repair order number, the claim number, and the name of the repair site estimator who is overseeing the repair.

The vehicle information display 356 includes information about the vehicle 130, such as the vehicle year, make, model, color, license plate number, and vehicle identification number.

The promised dates display 358 includes a record of dates for certain events involving the repair, such as the drop off date, the repair start date, the repair complete date, the pickup date, and the promised date that the repair would be completed. The promised dates display 358 helps to reduce miscommunication and ensure that the repair site and the customer 106 share the same understanding of the anticipated repair timeline.

Actions display 360 includes one or more selectable controls that initiate functions of the customer interface engine 270. In this example, the actions display 360 includes a message control 380, which can be selected by the customer 106 to send a message to the repair site. In some embodiments, the message control 380 causes the customer interface engine 270 to generate a new page including a message form. The message form includes at least a message field where the customer 106 can enter the message to be sent to the repair site. The message form can further include additional fields, such as a name field, and a contact information field where the user can enter a telephone number or e-mail address where the repair site user 134 can reach the customer 106. In another embodiment, the message control 380 initiates an e-mail message through the customer's own e-mail software or service. At least some of the information in the e-mail can be automatically inserted, such as the “to” address, and the subject (with the repair order number, for example).

Some embodiments include additional actions, such as actions to send messages to other users of the vehicle repair system (e.g., the insurance company, the rental car company, etc.).

Estimates display 362 includes a list of the estimates that have been prepared for the repair order. In this example, the estimates display 362 identifies an original estimate, and shows the date and time that the estimate was provided. A link to a full copy of the original estimate is also provided. In this example, the estimates display 362 also identifies a supplemental estimate, including the date and time that the supplemental estimate was provided, and a link to the full estimate. The full estimate is, for example, a downloadable PDF document that provides a detailed list of parts, repair services, and associated costs that will be required for the repair. In some embodiments, the repair does not proceed until the customer 106 has approved the estimate, as discussed in more detail below.

With reference to the second column of the detailed vehicle status page 350, the supplemental repairs display 364 is included at the top of this column in some embodiments so that it is prominently displayed on the detailed vehicle status page 350. Similarly, the delays display 366 is shown immediately below the supplemental repairs display 364. In this way, the customer 106 can quickly find information about any supplemental repairs that were identified in the status summary display 314 (FIG. 6), or any delays that were similarly noted.

In this example, a supplemental repair has been identified, and as a result, details of the supplemental repair are included in the supplemental repairs display 364. In this example, the supplemental repairs display 364 includes a supplement number, a description of the supplemental repair, a date and time that the supplement was entered, a link to the detailed estimate for the supplemental repair, and a status of the supplemental repair.

A supplemental repair is any repair that exceeds an original estimate. In some embodiments, before the repair is permitted to proceed, a detailed supplemental estimate must be prepared and provided to the customer 106, and the customer 106 must approve the supplemental estimate. In the illustrated example, the customer has not yet approved the estimate, and as a result the status is indicated as “awaiting approval.”

The supplemental repairs display 364 includes a link 384 to the detailed estimate for the supplemental repair, and a link 386 to initiate approval of the supplemental repair. In another embodiment, the supplemental repair process is automatically initiated by the customer interface engine 270 upon selection of the repair order from the customer home page 310, if the repair order has a supplement requiring customer 106 approval.

The link 384 can be selected by the customer 106 to download or view the detailed estimate.

In some embodiments, the estimate is by the repair site using a repair estimation system, and the output of the repair estimation system is the estimate document. The estimate document can then be uploaded by the repair site user to the status engine 222 for inclusion in the detailed vehicle status page. The document may be a portable document format (PDF) file, a word processing file, a spreadsheet file, an HTML file, or other suitable file formats.

The link 386 initiates the supplemental repair approval process through the customer interface engine 270. The supplemental repair approval process is illustrated and described in more detail herein.

The delays display 366 includes information about any events that have unexpectedly delayed, or are currently delaying, the repair. In this example, no events have unexpectedly delayed the repair, and so the delays display 366 shows “no delays at this time.” If an event had delayed the repair, the delays display 366 includes a description of the delay, a date that the delay was entered, a status of the delay (e.g., delay still in place, or delay removed), and a date that the delay was removed (if any).

The video display 368 includes thumbnail images of any videos that have been provided by the repair site 108 for the repair order. Videos can be taken to show aspects of the repair that may not be clearly understood, appreciated, or verifiable, from a written description or a photograph. For example, an improper movement of a part may (e.g., wobbling of a wheel, improper raising or lowering of the tailgate, etc.) may best be shown with a video. The videos can be provided by the repair site 108 in any suitable video format. In some embodiments, the videos are playable in the detailed vehicle status page 350, or can be selected to be shown in a separate and expandable window. In some embodiments, videos from third-party web sites can be included. Alternatively, in some embodiments a selectable control is provided in the video display 368 to share the video with third-party systems (e.g., Facebook, Twitter, MySpace, etc.).

The pictures display 370 includes thumbnail images of pictures that have been provided by the repair site 108 illustrating an aspect of the repair order. For example, pictures may be taken to show the original damage, and additional pictures can be taken throughout the repair process to show the progress that is being made, or to show additional damage that has been identified. In this example, the pictures display 370 includes three pictures, including a title, description, and date for each picture. The pictures are selectable to view an enlarged version of the picture or to download and save a copy of the picture. In some embodiments, a selectable control 388 is provided for each picture to share the picture with a third-party system (e.g., Facebook, Twitter, MySpace, etc.). Upon selection of the selectable control 388, the customer interface engine sends the picture to the third-party system to permit the system to utilize the picture. In some embodiments, the customer 106 is prompted by the third-party system to enter additional information, such as a username and password, to complete the sharing of the photograph. A message may also be provided by the customer 106 in some embodiments.

The project messages display 372 displays messages that have been sent to or from the customer 106 through the status engine 222. The messages include, for example, an identifier of who the message is from and who the message is to, a date and time that the message was sent, a subject of the message, the text of the message, and message attachments, if any. In this example, four messages are displayed, including three messages from the estimator at the repair site to the customer 106, and one message from the insurance company to the customer 106. Additionally, any messages sent from the customer 106 to another user can also be displayed in the project messages display 372.

The messages are used to keep open communication between the parties involved in the repair, and particularly between the customer 106 and the repair site 108. In some embodiments, messages are also sent to one or more e-mail addresses or by text message to a mobile phone, so that the customer does not have to log into the system in order to receive a message. The messages can include attachments, such as video, pictures, or estimates, if desired.

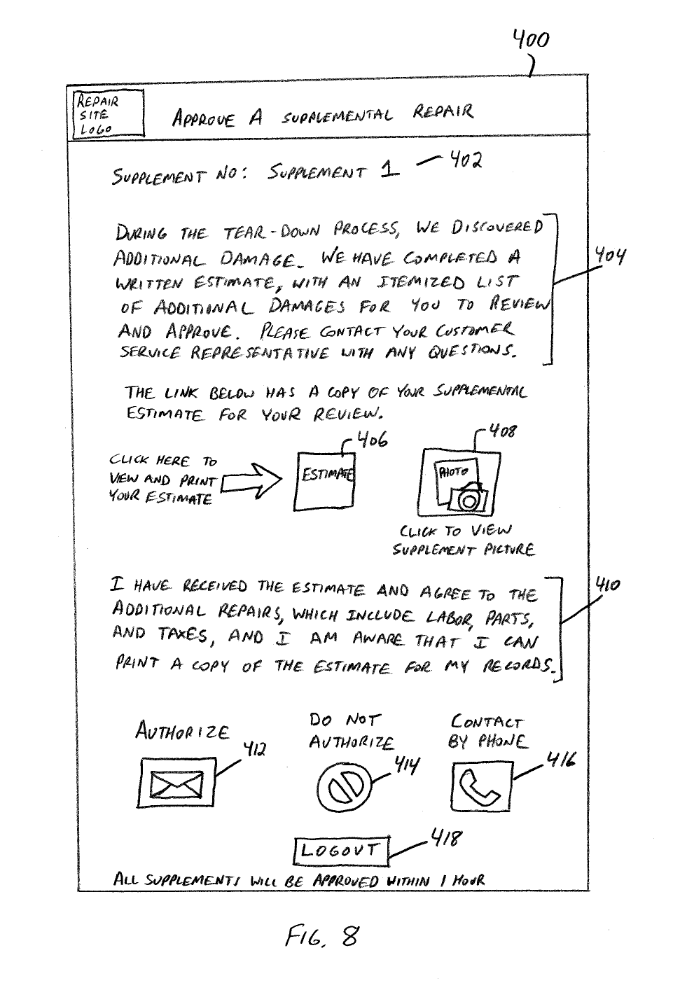

FIG. 8 is a screen shot of an example supplemental repair approval page 400. The supplemental repair approval page 400 informs the customer 106 that additional work is required that was not included in prior estimates, provides the supplemental estimate for the customer 106 to review, and permits the customer 106 to approve or decline to approve the supplemental repair.

In some embodiments, the supplemental repair approval page 400 is displayed automatically upon selection of a repair order from the status summary display (FIG. 6), if the repair order indicates that the supplemental repair status display 330 is pending approval. In another embodiment, the supplemental repair approval page 400 is displayed upon selection of the supplemental repair status display 330 from the status summary display 314. In yet another embodiment, the supplemental repair approval page 400 is displayed upon selection of the link 386 of the supplemental repairs display 364 in the detailed vehicle status page 350 (FIG. 7). Other embodiments display the supplemental repair approval page 400 at other times.

In this example, the supplemental repair approval page 400 includes a supplement number 402 (e.g., Supplement 1), a description 404, an estimate control 406, a pictures control 408, an approval statement 410, authorization control 412, denial control 414, contact control 416, and logout control 418.

The supplement number 402 is provided to identify the supplement. In some embodiments, supplements are numbered consecutively so that the consumer and the repair site can more easily distinguish between supplements, in the event that multiple supplements are needed for a single repair.

The description 404 provides an explanation of the supplemental repair. The description may explain why the repair was not originally identified, provide an explanation for what the repair is or why it is needed, or provide other information about the supplemental repair.

The supplemental repair approval page 400 includes estimate control 406 that can be selected by the user to view the detailed estimate that has been prepared for the supplemental repair. The estimate includes an itemized listing of all parts, labor, and taxes that will be required to complete the supplemental repair. Upon selection of the estimate control 406, the estimate is displayed in another page. In another embodiment, the estimate is downloaded to the customer computing device 124, and opened in a separate program where it can be viewed by the customer 106.

The pictures control 408 is provided if there are additional pictures included with the supplement that illustrate aspects of the supplemental repair. The pictures control 408 is selected to view the one or more pictures. In some embodiments, the pictures are displayed in another page, while in other embodiments the pictures are displayed overlaying the supplemental repair approval page 400. In another embodiment, the pictures are downloaded to the customer computing device 124 where they can be saved and viewed by the customer 106.

The approval statement 410 is included that includes contractual language that the customer 106 is prompted to review, indicating that the customer has reviewed and approved the additional repairs indicated by the supplemental repair.

After review of the approval statement 410, the user is prompted to authorize or deny the supplemental repair with the authorization control 412 or the denial control 414, or alternatively to contact the repair site by selecting the contact control 416.

If the customer 106 approves of the supplemental repair, the user selects the authorization control 412. A message is then sent to the repair site indicating that the supplemental repair has been approved. In some embodiments, the message is sent automatically through the vehicle repair system. The message can also be sent to one or more e-mail addresses, or to one or more mobile phones through a text message, if desired, to alert the repair site user that the supplemental repair has been approved.

In some embodiments, rather than the message being sent automatically, the customer interface generates an e-mail that the customer 106 can send to the repair site. For example, the supplemental repair approval page 400 can initiate a new e-mail message using the customer 106's default e-mail program as configured in the customer's browser. The e-mail automatically includes the appropriate e-mail address(es) in the “to” field, so that the e-mail will be properly directed to the appropriate repair site user 134, and also includes the approval statement 410 in the message body. The message body may also prompt the user to provide additional information, such as a name (as a digital signature) and may request other personal identifying information, such as a driver's license number as further verification that the message was sent by the customer 106. The message can further include a subject, such as including the repair order. The message is then sent to the repair site. Upon receipt, the repair site user 134 reviews the authorization message and confirms that it was properly signed and, if required, that the proper verification information was provided. If so, the repair site 108 then proceeds with the supplemental repair. In addition, once the supplement has been approved, the status of the supplement is updated to approved with the vehicle status engine 280 (FIG. 5), so that the status summary display 314 (FIG. 6) and supplemental repairs display 364 (FIG. 7) are also updated.

If the user does not authorize the supplemental repair, the user clicks on the denial control 414. A message is then sent to the repair site (either through the vehicle repair system 102, in an e-mail message, or the like) indicating that the supplemental repair has been denied by the customer 106. In this case, the repair site 108 does not perform the additional repairs, or may contact the customer 106 to discuss the repairs further.

The contact control 416 can be selected by a user that prefers to contact the repair site directly. Upon selection of the contact control 416, contact information is displayed. In another embodiment, selection of the contact control 416 initiates a call to the repair site by dialing the repair site's telephone number. In another embodiment, the contact control 416 initiates a message to the repair site, which allows the customer 106 to ask questions or request additional information about the supplemental repair before authorizing or denying the supplemental repair.

The logout control 418 can be selected to log out of vehicle repair system 102.

FIGS. 9-11 illustrate the operation of an example repair site interface engine 272, shown in FIG. 5. The repair site interface engine 272 interacts with one or more repair site users 134 (FIG. 1) through one or more repair site computing devices 132.

FIG. 9 is a screen shot of an example repair site home page 430. The repair site home page 430 is displayed, for example, after a repair site user 134 has logged in, such as by providing a username and password for a user account that is associated with a repair site.

The repair site homepage includes a list 432 of one or more open repair orders for the repair site 108, a navigation menu 434 that includes controls that are selectable to initiate various functions of the repair site interface engine 272 (FIG. 5), a configuration menu 476, links 484 and 486 to the store and jobs portions of the vehicle repair system, a help control 488, and a calendar tool 490.

The list 432 includes a status summary display 440, 442, and 444 for each repair order that has not yet been completed. In this example, the status summary display 440, for example, includes information about the repair order 12345 for Jack Brown (as illustrated in FIGS. 6-7), whose repair is still pending.

Each summary display 440, 442, and 444 includes information about the associated repair order, such as the name of the customer 106, the repair order number, the estimator, the claim number, the customer's phone number, the date and time that the status was last updated, the delay status, and the supplemental repair status. In another example embodiment, the summary display includes a username, a repair order number, a claim number, a name of the customer 106, a phone number of the customer 106, a date and time of the last message, and a link to view the customer login history. The summary displays can alternatively include additional, less, or different information, as desired.

The repair site home page further includes a navigation menu 434. In this example, the navigation menu is arranged along a right side of the page, but in other embodiments the menu can be positioned in other locations, or can be presented in different forms, such as in a drop down or slide out menu.

In some embodiments, the navigation menu 434 is a dashboard specially configured for an account manager at the repair site. In some embodiments, the repair site users 134 have different user types, such as an account manager user and a working user. The account manager user is permitted to change any of the settings or options for the repair site, but the working user is only permitted to enter information to update the status of a repair order. In other words, certain of the options illustrated in FIG. 9 may not be available to a repair site user 134 that has been assigned the user type of working user. This prevents working users from accidentally or intentionally making changes that the account manager does not approve of.

In this example, the navigation menu includes a create repair order account control 446, create new insurance account control 448, insurance company management control 450, create new rental partner control 452, rental partner management control 454, create new employee account control 456, employee management control 458, repair order archive control 460, customer satisfaction control 462, advertisements control 464, add link to web site control 466, supplement approval control 468, manually approve supplement control 470, remove delay control 472, view all repair orders control 474.

The create repair order account control 446 is selected to initiate the creation of a new repair order. Upon selection, the repair site user 134 is prompted to enter information about the repair order, such as information about the customer 106 (e.g., name, address, home and work phone number, mobile phone number, name of mobile phone carrier, e-mail address, fax number, driver's license number, etc.), information about the vehicle (e.g., make, model, year, color, license plate number, vehicle identification number), insurance company information (e.g., name of insurance provider, policy number, claim number), relevant dates (e.g., drop off date, repair start date, repair complete date, promised date, pickup date), rental car information (e.g., company name, car make, model, year, color, and identification number), repair site information (e.g., name of the customer service representative handling the repair, name of the estimator), and a brief description of the repair order. The information is stored in status data 232 (FIG. 5). Additional, less, or different information is included in other embodiments. For existing customers, some of the information can be looked up, such as by typing in the user's name and selecting it from a list. Then, the repair site user can ask the user to verify the information, and make any changes that are necessary.

The create new insurance account control 448 is selected to initiate the creation of a new insurance company account. Upon selection, the repair site user 134 is prompted to provide information such as a username, a first and last name, an initial password, an e-mail address, a phone number, and information about the insurance company (e.g., company name, address, telephone number, etc.). Once created the information can be given to an insurance company user 138 to permit the insurance company to access information within the vehicle repair system. In some embodiments, an e-mail is sent to the insurance company user 138 (at the e-mail address provided) providing login instructions.

The insurance company management control 450 is selected to initiate management of the insurance company accounts. Upon selection, a list of insurance company accounts is displayed, along with options to edit or delete the accounts.

The create new rental partner control 452 is selected to create a new rental car company user account. Upon selection, the repair site user 134 is prompted to provide information such as a username, a first and last name, an initial password, an e-mail address, a phone number, and information about the rental car company (e.g., company name, address, telephone number, etc.). Once created the information can be given to a rental car company user to permit the rental car company user to access information within the vehicle repair system. In some embodiments an e-mail is sent with login instructions.

The rental partner management control 454 is selected to initiate management of the rental car company accounts. Upon selection, a list of rental car company accounts is displayed, along with options to edit or delete the accounts.

The create new employee account control 456 and employee management control 458 operate in a similar way to permit the creation and management of employee accounts within the repair site 108. In embodiments utilizing different user types for repair site users 134 (e.g., account manager user and working user types), the user type can be selected through these pages.

The repair order archive control 460 is selected to display repair orders that have previously been marked as completed. The list can be browsed or a search can be performed, such as by a customer's last name, etc. The repair order can be viewed or re-opened. A repair order may need to be reopened, for example, if the repair order was inadvertently closed, or if a customer returns because the repair did not resolve all of the vehicle's problems.

Upon completion of a repair order, a customer satisfaction survey is provided to the customer 106. The customer satisfaction surveys can be reviewed and managed with a customer satisfaction page by selecting the customer satisfaction control 462. A list of customer satisfaction surveys is provided, along with the repair order number, name of the customer, number of days since the survey was completed, and an indication of whether or not the survey has been completed, for example. Several actions can be performed from the customer satisfaction page, including automatically filling out a form, reading a form, and e-mailing a customer. Automatically filling out a form involves inserting known information into the appropriate location in a form, such as the repair number, customer number, etc. Reading the form opens the completed form so that it can be reviewed by the repair site user 134. E-mailing the customer initiates an e-mail to the customer requesting that the customer complete the survey. The e-mail can include the survey form, or include a link to the customer satisfaction survey page, which includes the questions to be completed by the customer 106.

The advertisements control 464 is selected to manage advertisements. Advertisements can be a source of revenue for the repair site owner, which can help to offset costs associated with a subscription or other fee for using the vehicle repair site. An advertisements page manages the advertisements, by permitting the repair site user to add or delete advertisements, and to define URLs that the advertisements are linked to. The repair site owner can charge companies a fee to be included as one of the advertisements, a per placement fee, or a per click fee for each time an advertisement is clicked by a customer. The status engine 222 operates to manage the advertisements, and can also operate to track advertisement placement and click counts.

The add link to web site control 466 is selected to display instructions for adding a link to the vehicle repair system 102 to another web site, such as the web site of the repair site 108. The resulting page includes instructions for adding a graphical link to a web site, and instructions for providing a text link to a web site. The appropriate hypertext markup language (HTML) code is also provided, so that it can be copied and inserted into the HTML for the web site.

The supplement approval control 468 is selected to initiate a supplement approval process. The supplement approval process can be performed to check for supplement messages and, once received, to update the status of the supplemental repair order. For example, upon selection of the control 468, the repair site interface engine 272 retrieves data from any supplement approval messages that have been received from a customer 106, and provides a list of the supplement approval messages that have been received. A control is then provided to process the supplemental approval messages. Upon selection of the control, the repair site interface engine 272 interacts with the vehicle status engine to process the supplemental approval messages and update the status of the supplemental repairs to approved. Processing can include confirmation that the supplemental approval message includes a digital signature, and confirmation of additional identification information, such as the customer 106 driver's license number (or other identification information) provided in the message. If any of the messages indicate a denial of the supplement, the supplemental repair is similarly updated to indicate that the supplemental repair has been denied. A summary report is provided showing the results of the processing.

The manually approve supplement control 470 is provided to permit a repair site user 134 to manually approve a supplement. The manual approval process can be used, for example, when the repair site user 134 receives a telephone call from the customer 106 providing an oral authorization of the supplemental repair, or if the supplemental repair is approved in person by the customer 106. It can also be used if an e-mail or fax is received by the repair site user 134, which was not processed through the status engine 222 (FIG. 5). The manual approval process prompts the user to enter or select a repair order, a supplement number, a customer name, and customer identification information (such as the customer driver's license number), and then to select a control indicating that the repair site user 134 has received instructions from the customer 106 in which the customer 106 approved the supplemental repair. In some embodiments, the approval from the customer must be in writing, include a signature or digital signature, and include customer identification information, such as the customer driver's license number. In some embodiments, the manual approval must identify a date and time that the supplemental repair was authorized, the customer's name, the telephone number called (if any), and be associated with the supplemental repair order estimate that describes the additional repairs, parts, labor, and total additional cost.

The remove delay control 472 is selected to remove a project delay from a repair order, such as when the issue causing the delay has been resolved. For example, if a delay is caused by the need to order a part, the delay can be removed from the repair order once the part is received. After selection of the remove delay control 472, the repair site user 134 is prompted to enter or select the repair order, or to identify the issue that has been resolved. The customer interface engine 270 interacts with the vehicle status engine 280 to remove the project delay from the repair order and to update the vehicle status to indicate that there is no delay (if appropriate) and that the repair is in process.

The view all repair orders control 474 is provided to return to the repair site home page 430 from any other repair site page. In addition, in some embodiments the repair site home page 430 includes search and filter operations that can be performed to show only a subset of the repair orders that are currently pending. The view all repair orders control 474 can be selected to clear all filters or search queries, and to display the complete list of all pending repair orders.

Turning now to the configuration menu 476, the configuration menu provides several options that can be selected to customize certain operations of the status engine 222. In this example, the configuration menu 476 includes set e-mail formats control 478, set company logo control 480, and set supplement e-mail control 482.

The set e-mail formats control 478 is selectable to configure or edit message templates. The message templates include, for example, a template for project messages, a template for supplemental repair messages, and a template for delay order messages. Upon selection of one of the messages, an editor is displayed in which the template can be modified for the respective message. The text, format, an content of the message can then be modified as desired, and may include HTML or plain text, and can further include multimedia elements (e.g., images, animation, video, web links, etc.) as desired. The message templates will typically include a standard message to be sent, so that the repair site user 134 does not have to manually type out common messages each time. The message templates can include a signature block including contact information, or any other desired information. The template can also include blanks or fields to be manually or automatically filled in when the message is being sent, such as to personalize or customize the messages for the specific situation.

The set company logo control 480 is selected to select a company logo to be used by the status engine for interactions involving the repair site 108. After selecting this control, the user is prompted to upload a company logo. The company logo is then used to customize certain pages of the status engine interfaces to associate the pages with the repair site. For example, the customer interface engine 270 pages, repair site interface 272 pages, insurance company interface engine 274 pages, and rental car company interface engine 276 pages are updated to include the company logo, so that the pages are associated with the repair site 108. This allows multiple repair sites 108 to utilize the status engine, while customizing the pages so that they are identifiable as being associated with the appropriate repair site. Additional customization can be included in various pages as well, such as including the company name, company contact information, links to the company web site, etc., as desired.

The set supplement e-mail control 482 is provided to manage one or more e-mail accounts to be used for sending and/or receiving supplemental repair communications. The repair site user 134 is initially prompted to enter an e-mail address to be used. In some embodiments, a third-party e-mail service is utilized, such as the Google Gmail system. In this example, the e-mail address and password are received, or the user is prompted to create a new account. Once the e-mail account has been identified, the e-mail account can be used for sending and/or receiving messages regarding supplemental repairs. The e-mail account information can also be subsequently modified using the set supplement e-mail control.

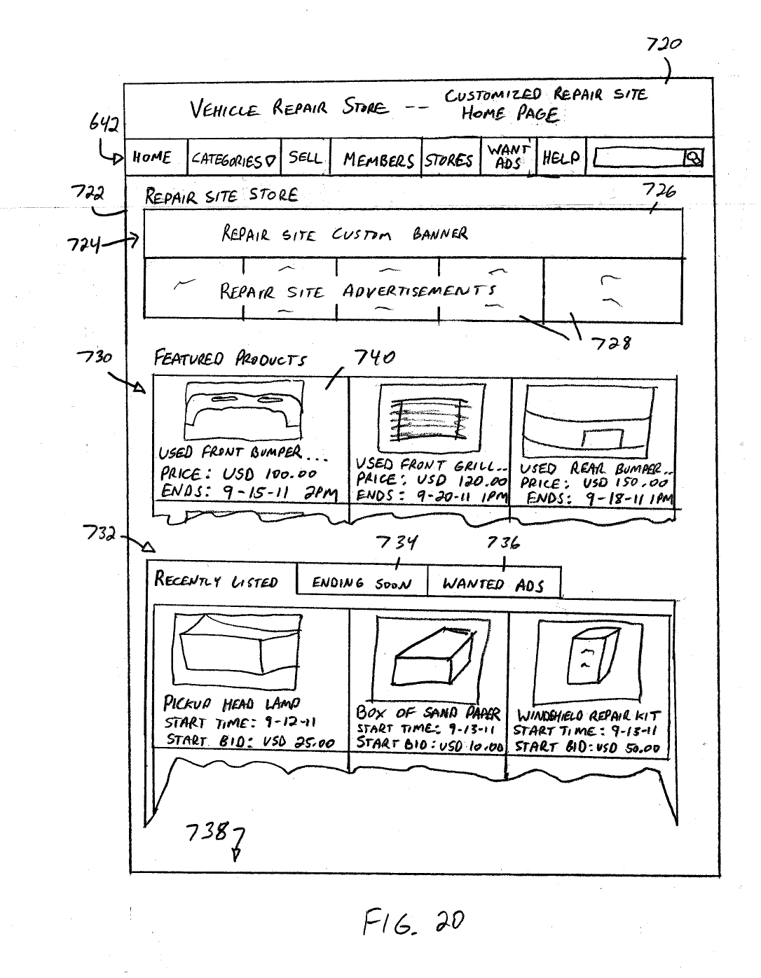

Links 484 and 486 are provided to navigate to the store and jobs portions of the system, respectively. For example, upon selection of link 484, the store home page 720 is displayed, as shown in FIG. 20. Upon selection of link 486, the jobs home page 790 is displayed, as shown in FIG. 24.

Help control 488 is provided to display information to assist the repair site user 134 in using the status engine 222. In some embodiments, a how-to guide is displayed. In some embodiments, a help interface is provided, such as including frequently asked questions, and a searchable database of help topics.

Calendar tool 490 is also provided in some embodiments. Because the repair site user 134 is frequently providing estimates to customers relating to dates (the date the vehicle is brought in, the repair start date, the repair complete date, the delay date, the supplemental repair date, the promised date, the completed date, etc.), a calendar tool 490 is provided as a convenient location to view these dates in a monthly calendar view. The calendar tool includes selectable controls to navigate forward or backward to other months, if desired.

FIG. 10 illustrates a portion of an example detailed vehicle status page 500 provided by the repair site interface engine 272 (FIG. 5). The example detailed vehicle status page 500 is similar to the detailed vehicle status page 350, shown in FIG. 7, except for several notable differences. As a result, the detailed vehicle status page 500 is not separately illustrated and described herein in detail, except for the portions shown in FIG. 10.

The detailed vehicle status page 500 is displayed upon selection of one of the summary status displays 440 of the repair order list 432 by the repair site user 134. Similar to the detailed vehicle status page 350, shown in FIG. 7, an example of the detailed vehicle status page 500 includes customer information display 352, repair information display 354, vehicle information display 356, promised dates display 358, actions display 360, estimates display 362, supplemental repairs display 364, delays display 366, videos display 368, pictures display 370, and project messages display 372. In this way, the customer 106 and the repair site user 134 are largely seeing the same information in each of the detailed vehicle status pages 350 and 500.

However, in some embodiments the repair site's version of the detailed vehicle status page 500 includes several additional features. For example, the actions display 360 includes additional tools, as described in more detail below. In addition, a private messages display is included in some embodiments where a record of messages can be maintained by the repair site that are not accessible to other users other than repair site users 134. In addition, in some embodiments the detailed vehicle status page 500 also includes a third column including the navigation menu 434 as shown in FIG. 9, to provide access to the same controls (446 to 490) and associated features described with reference to FIG. 9.

FIG. 10 is a screen shot of a portion of the detailed vehicle status page 500 as displayed to the repair site user 134. The portion includes the actions display 360. In this example, the actions display 360 includes an upload picture control 502, add message control 504, add private message control 506, upload estimate control 508, create supplement control 510, create delay order control 512, upload video control 514, close repair order control 516, and delete repair order control 518.

The upload picture control 502 is selected to upload a picture to the repair order. Upon selection, the repair site user 134 is prompted to upload the picture, and the picture is then stored in status data 232. In addition, the repair site user 134 can also provide a picture title and description, if desired. Some embodiments further include a “send e-mail to customer” option, which can be selected to cause the status engine to send an e-mail to the customer 106 alerting the customer 106 that a picture has been uploaded, or including a copy of the picture. After uploading, the pictures are then included in the pictures displays 370 of the detailed vehicle status pages 350 and 500.

The add message control 504 is selected to add a new project message. Upon selection, the repair site user 134 is prompted to enter a message. In some embodiments, the repair site user 134 is prompted to select whether to send a copy of the message via e-mail or as a text message. Some mobile phone carriers permit text messages to be sent as an e-mail message, which is then transmitted as a text message (e.g., short message service (SMS) text message). For example, customers 106 subscribing to the Sprint mobile phone service can receive a text message if an e-mail is sent to “[telephone number]@messaging.sprintpcs.com,” where [telephone number] represents the customer's mobile phone number. Other carriers have similar services. Accordingly, the system can send a copy of the message to the user as a text message, if the text message option is selected by the repair site user 134, if the system knows the mobile phone number and carrier messaging address. After a message has been sent, the message is displayed in the project messages display 372 of the detailed vehicle status pages 350 and 500.

The add private message control 506 is selected to add a private message to the repair order. The private message is a message that is visible to the repair site users 134, and is not visible to the customer 106. After entry, the private messages are shown in a private message display of the detailed vehicle status page 500 (similar to the project messages display 372, shown in FIG. 7), and is not shown in the detailed vehicle status page 350. In some embodiments, the repair site user 134 is prompted to select whether the private message should be shown to the insurance company user 138. If so, the private message can be viewed by the insurance company on the respective detailed vehicle status page. Alternatively, or in addition, the private messages can be sent directly to the appropriate people using e-mail or text messaging, for example.

The upload estimate control 508 is selected to initiate the uploading of an estimate to a repair order. Upon selection, the repair site user 134 is prompted to upload the estimate document, by selecting the appropriate document, and to provide a title for the estimate (such as “original estimate,” “supplement 1,” “supplement 2,” etc.). Once uploaded, the estimate appears in the estimates display 362.

The create supplement control 510 is selected to initiate a supplement approval process. After uploading of the appropriate supplement estimate, the create supplement control 510 is selected by the repair site user 134 to update the vehicle status to indicate that a supplemental repair has been identified, and that approval of the supplemental repair is required. In addition, a supplemental repair message is created and sent to the customer 106. An example supplemental repair message page 530 that is displayed after selecting the create supplement control 510, is illustrated and described with reference to FIG. 11.

The create delay order control 512 is selected to add a delay to the repair order. The repair site user 134 is prompted to confirm the customer 106 contact information (e.g., e-mail or SMS text address), and the content of the delay order message. In some embodiments, the repair site user is prompted to enter a description of the issue causing the delay, as well as an estimate of how long the issue will delay the repair. Once completed, the delay order message is sent and the vehicle status data 300 is updated to indicate that the repair order has been delayed.

The upload video control 514 is selected to upload a video to the repair order. Upon selection, the user is prompted to select and upload the video, and to provide a title and description of the video. Once provided, the video is included in the videos display 368 of the detailed vehicle status pages 350 and 500.

The close repair order control 516 is provided to close a repair order upon completion of the repair. When selected, the repair site interface engine 272 interacts with the vehicle status engine 280 to update the status of the repair order as completed. Subsequently, the repair order is no longer included in active repair order lists, such as lists 312 (FIG. 6) and 432 (FIG. 9), but is accessible through the repair order archive control 460 (FIG. 9), if needed.

If a repair order has been opened in error, the delete repair order control 518 is selected to delete the repair order. Upon selection, the repair order is removed from status data 232 and is no longer included in any lists of repair orders.

More, fewer, or different tools are included in actions display 360 of the detailed vehicle status page 500 in other embodiments.

FIG. 11 is a screen shot of an example supplemental repair message page 530, such as displayed after selection of the create supplement control 510, shown in FIG. 10. The supplemental repair message page 530 prompts the user to enter or select information for the supplemental repair message. In this example, the supplemental repair message page 530 includes a repair order number field 532, supplement number field 534, phone number field 536, estimate attachment field 538, supplement picture attachment field 540, add more control 542, message field 544, author field 546, and submit control 548.

To generate the supplemental repair message, the repair site user is prompted to enter, select, or confirm the repair order number in repair order number field 532, the supplement number in supplement number field 534, phone number for sending an SMS text message in phone number field 536, estimate to be attached in the estimate attachment field 538, picture to be attached in the supplement picture attachment field 540, a message in the message field 544, and a name of the repair site user 134 that created the supplemental repair message in the author field 546. If additional pictures are desired, an add more control 542 is provided to add additional picture attachment fields 540 to the supplemental repair message page 530.

In some embodiments, one or more of the fields are automatically populated based on the stored customer data, repair site data, and vehicle status data, so that the repair site user 134 simply needs to confirm the accuracy of this information, and does not need to manually enter the information into each field. For example, the default supplement repair message is inserted into message field 544. Once the repair site user has approved the message, the submit control 548 is selected to cause the status engine 222 to send the message to the customer 106, and to update the vehicle status data 300 (FIG. 5) to indicate that the vehicle repair is on hold pending approval of the supplemental repair.

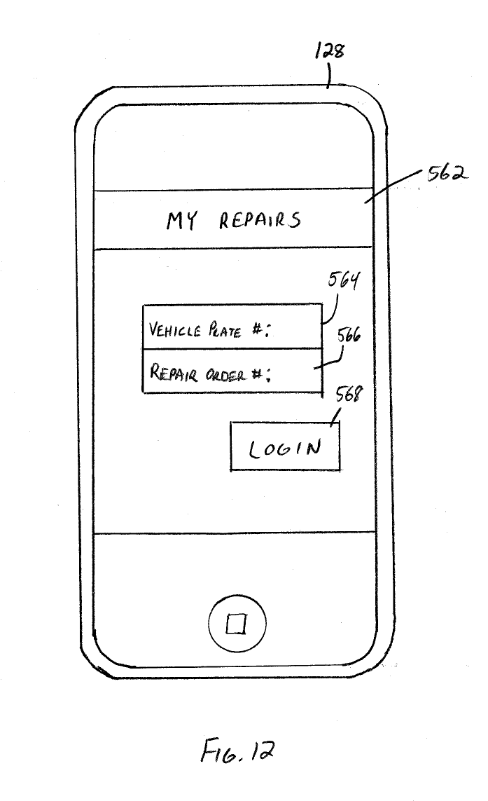

FIGS. 12-16 illustrate several exemplary pages of a mobile user interface generated by the customer interface engine 270, which is configured for use on the customer mobile computing device 128.

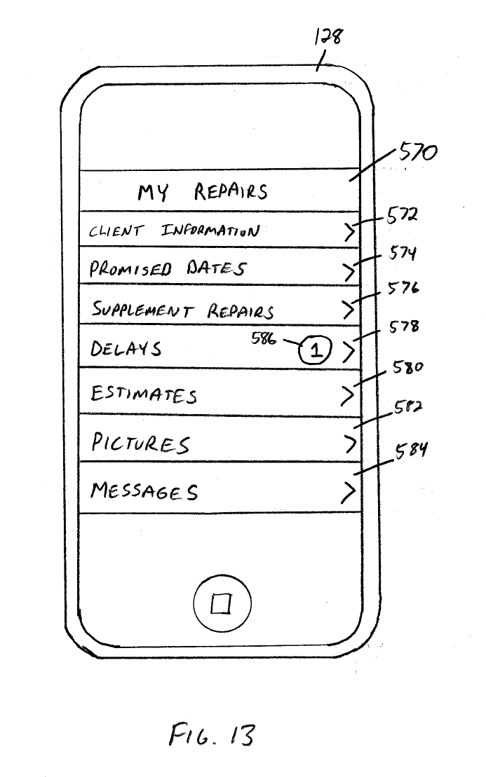

FIG. 12 is a screen shot of an example login page 562 displayed on the mobile computing device 128. The login page prompts the user to provide login information. For example, the prompt 564 prompts the customer 106 to enter the vehicle license plate number, and prompt 566 prompts the customer 106 to enter a repair order number. The login control 568 is then selected. If the login information is validated, the user interface proceeds to display the customer home page 570, shown in FIG. 13. Other information can alternatively be used as login information, such as a username and password; a license plate and telephone number; or other identifying information.

FIG. 13 is a screen shot of an example home page 570 displayed on the mobile computing device 128. The home page 570 provides an interface through which the customer 106 can obtain additional information about the status of the repair. In this example, the home page 570 includes client information control 572, promised dates control 574, supplement repairs control 576, delays control 578, estimates control 580, pictures control 582, and messages control 584. At least some of the controls can further include an update display 586, which shows any new information that has been updated since the last time that the customer 106 viewed the associated information. For example, the update display 586 indicates that one new delay has been added to the repair order.

The controls can be selected to cause the customer interface engine 270 to display additional information. The client information control 572 can be selected to display the client information. The promised dates control 574 can be selected to display promised dates associated with the repair order. The supplement repairs control 576 is selected to display any supplemental repairs for the repair order. The delays control 578 is selected to display any delays for the repair order. The estimates control 580 is selected to display estimates for the repair order. The messages control 584 is selected to send and receive messages.

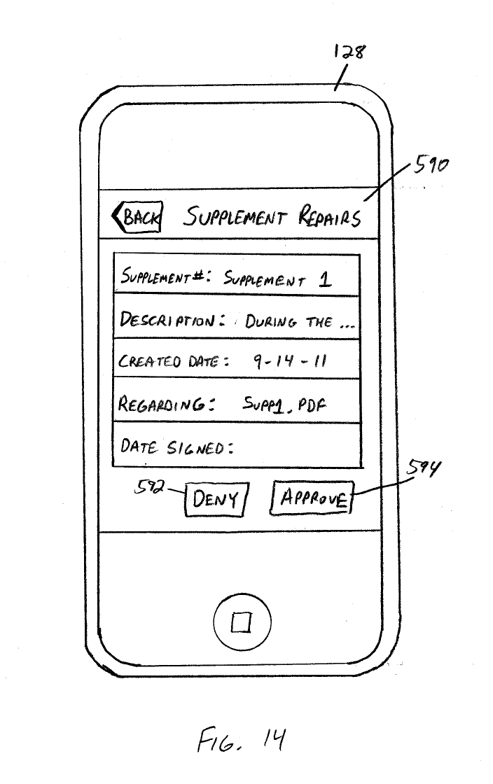

FIG. 14 is a screen shot of an example supplement information page 590 displayed on the customer mobile computing device 128. The supplement information page 590 is displayed, for example, after selection of the supplement repairs control 576. Information about the supplemental repair is displayed, such as the supplement number, the description, the date created, the estimate for the supplement, and the date that the supplement was approved. The fields can be selected to view additional information.

If a supplement is awaiting customer 106 approval, the deny control 592 and the approve control 594 are provided for receiving the customer's response. In some embodiments, a digital signature (or other information) must also be received from the user, and in such embodiments the user is prompted for the digital signature or additional information. Alternatively, an e-mail message is populated for review and approval of the customer 106, similar to that described with reference to FIG. 8.

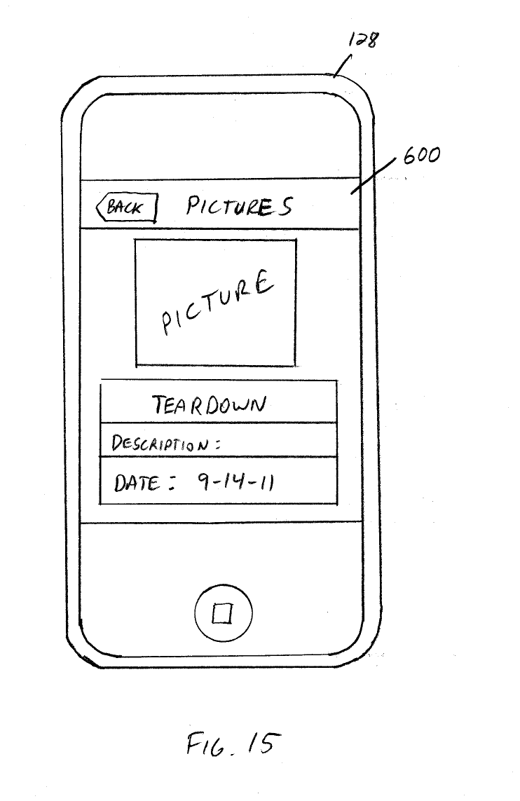

FIG. 15 is a screen shot of an example pictures page 600 displayed on the customer mobile computing device 128. The pictures page 600 displays one or more of the pictures for the repair order.

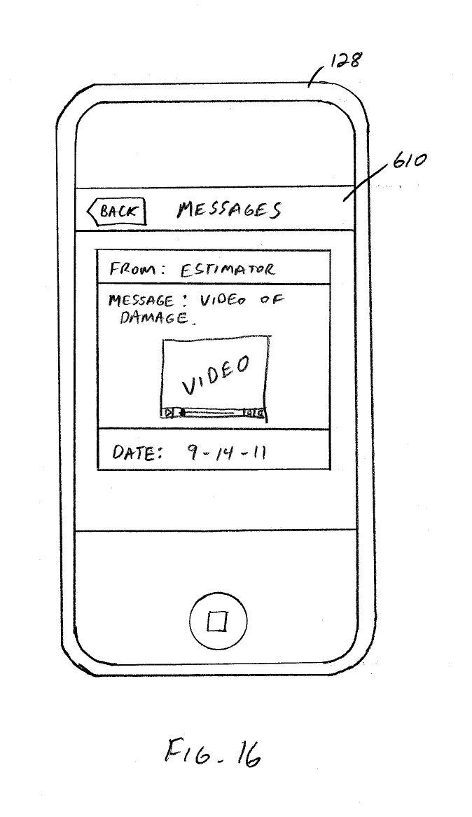

FIG. 16 is a screen shot of an example messages page 610 displayed on the customer mobile computing device 128. The messages page 610 displays one or more of the messages for the repair order. In some embodiments, messages can similarly be sent through a messages page 610.

FIGS. 17-23 illustrate the operation of an example store engine 224.

FIG. 17 is a schematic block diagram of an example store engine 224 that saves data in and retrieves data from store data 234. In this example, the store engine 224 includes a centralized store interface engine 620, and a plurality of customized repair site store interface engines including customized repair site store interface engines 622 and 624. The store data includes repair site store data 626 and repair site store data 628.

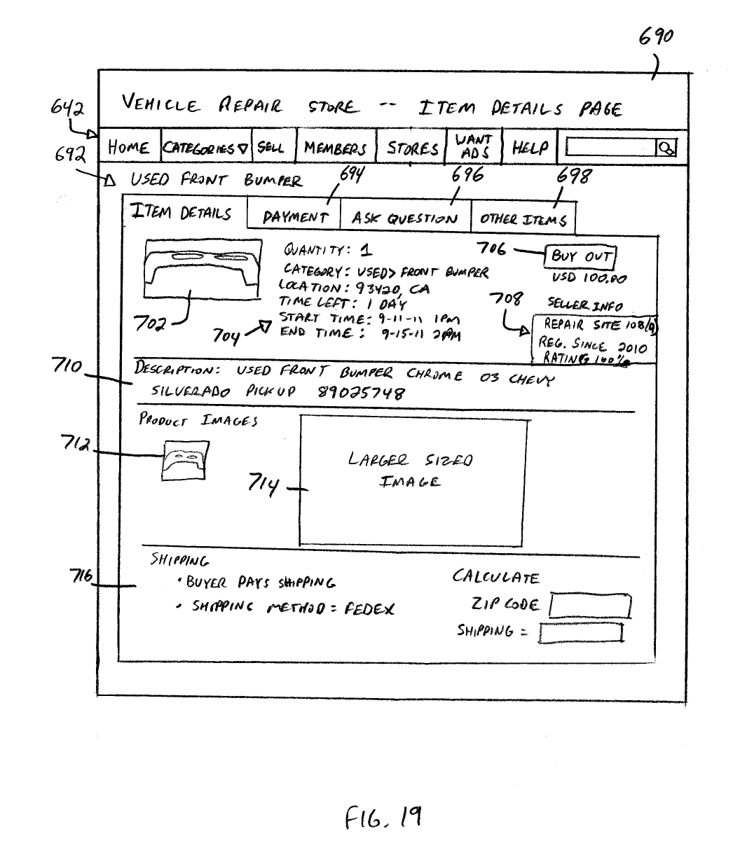

The centralized store interface engine 620 provides a centralized store interface through which products can be advertised and sold from a variety of different sellers. The sellers include, for example, the repair sites 108 including at least a first repair site and a second repair site. An example of the operation of the centralized store interface engine 620 is illustrated and described with reference to FIGS. 18-19.

The customized repair site store interface engines 622 and 624 customized store interfaces through which products can be advertised and sold from a single seller. For example, the customized repair site store interface engine 622 operates to advertise and sell products from the first repair site, and the customized repair site store interface engine 624 operates to advertise and sell products from the second repair site. An example of the operation of the customized repair site store interface engine is illustrated and described in more detail with reference to FIG. 20. Many embodiments will include more than two customized repair site store interface engines and associated store data, as represented by ellipses 630.

The customized repair site store interface engines 622 and 624 provide a store front that is customized for the particular repair site. As a result, a repair site can direct its own customer 106 to the customized repair site store interfaces where the customer 106 can view products that are available only from that repair site. Similarly, a customer interested in finding out what products are available from a particular repair site, can go directly to that repair site's store interface. For example, the customized repair site store interface may be preferred by a customer that is looking for a particularly large or heavy product that the customer is willing to pick up from a nearby repair site, but is not willing to have shipped from a more distant repair site.

On the other hand, the centralized store interface engine 620 compiles all of the products that are available from any of the repair sites into a single interface, where a potential customer can view all of the products that are available for purchase from any of the repair sites. This store interface may be preferred by a customer that needs to locate a particular product, but does not care which repair site the product comes from.

In some embodiments, the seller can select whether a given product should be listed in the centralized store interface, or in the repair site store interface, or both.

The data regarding the repair sites and the products available from the repair sites is stored in store data 234. The product data is associated with a particular repair site. For example, data associated with products available from the first repair site is stored in repair site store data 626, while data associated with products available from the second repair site is stored in repair site store data 628. The customized repair site store interface engines 622 and 624 therefore save and retrieve data only from the respective repair site store data 626 or 628, while the centralized store interface engine 620 uses the combination of data from all of the repair site store data 626 and 628.

The repair site store data 626 and 628 includes both repair site information and product data. The repair site information includes, for example, the name of the repair site, a logo for the repair site, a repair site custom banner, repair site advertisements, a store description, store specials, repair site policies, store metadata keywords, store logo, store layout selection, and store page customization selections. The repair site information is then used by the customized repair site store interface engine for customizing the repair site store interface.

The product data includes, for example, a title of the product, a description of the product, one or more product categories, a listing type (e.g., auction, sale, auction/sale, etc.), settings (e.g., currency, quantity, price range, item listing features (highlighting, home page featured, category page featured, bolded item), end time, private products (which are not included in generalized listing pages and search results), one or more images, videos, or file attachments, an automatic relist selection, a location, shipping and payment details (whether buyer or seller pays for shipping, cost of shipping, cost of insurance, other details, shipping method), direct payment selection (e.g., whether payment through PayPal or other third party payment server is accepted), and types of other payments that are accepted (e.g., credit card, western union, etc.).

FIG. 18 is a screen shot of an example home page 640 generated by the centralized store interface engine 620 (FIG. 17). In this example, home page 640 includes a toolbar 642, and product listing display 644. The toolbar 642 includes, for example, a home control 650, a categories control 652, a sell control 654, a members control 656, a stores control 658, a want ads control 660, a help control 662, and a search control 664.

The toolbar 642 provides various controls that initiate operations of the centralized store interface engine 620.

The home control 650 is selected by the user to return to the home page 640, shown in FIG. 18. This is most helpful when the user has navigated away from the home page 640, and wants to quickly return to the home page 640.

The categories control 652 is a drop-down menu from which the user can select a category for limiting the product listings shown in the home page 640. Examples of categories include, for example, aftermarket parts, auto body supplies allied, automotive refinishes, automotive services, businesses for sale, computer software, custom wheels, custom auto parts, equipment, new cars, new OEM parts, paint supplies, small tools, used, used cars, used equipment, used part, used tools, and vintage cars. Once a category is selected, the home page 640 is updated to show products assigned to the selected category.

The sell control 654 initiates the creation of a new product listing. The user is prompted to login, or register a new account. Then, the user is prompted to provide product information for the creation of a new listing. Examples of the product information are described herein. If the user is not associated with a repair site store interface, the user can still list products on the centralized store interface. In this case, the products will only appear in this interface, and will not be displayed in a customized repair site store interface. If the user is associated with a repair site store interface, then the product is included in that interface as well.

The members control 656 is selected to prompt a user to login or to provide access to member features. Member features include user settings, history, purchase or sale records, for example.

The stores control 658 provides access to particular repair site store interfaces. In some embodiments, upon selection of the stores control 658, a list of at least some of the repair site store interfaces is provided. In some embodiments, a search can be conducted for a particular store, such as by keyword or by location. Upon selection of a store, the customized repair site store interface home page is displayed, such as shown in FIG. 20.

The want ads control 660 provides access to a want ads page. While the home page 640 displays information about products that are available, the want ads page displays information about products that customers want to purchase. Similar product information is provided in the want ads, such as a description of the product. The product information can also include a price that the customer is willing to pay for the product, and a desired quality of the product (e.g., new, used, new-in-box, excellent, good, any, etc.).

The help control 662 provides access to additional information to guide the user in the use of the store engine 224. The help information can include a user's guide, answers to frequently asked questions, an overview of the store engine 224 features, a searchable database of help topics, a topical index of help topics, and contact information for customer service representatives, for example.

Search control 664 is provided to perform searches for products. In this example, the search control 664 includes a search query field where a user can enter a search query including keywords. In some embodiments, search limitations can also be provided, such as a selection of a particular category of products to be searched, a location to be searched (e.g., within X miles of Y, within a particular city, etc.), or other search limitations. Upon receipt of the search query, a search is performed for products that match the search query, and the results are listed in home page 640.

The products are listed in home page 640 in the product listing display 644. In some embodiments, the product listing display 644 includes several different sections, such as a featured products display 670, a recently listed products display 672, an ending soon display 674, and a wanted ads display 676. In addition, a general list of products 678 is also included in some embodiments. The general list of products 678 includes all (or a subset) of the products, regardless of whether the products are featured, recently listed, ending soon, etc.

A summary display 680, 682, 684 is provided for each product in home page 640. The summary display includes, for example, a picture of the product, a title of the product, an asking or current price of the product, and an ending date of the product. Other summary displays can be used in other embodiments, such as those shown in recently listed products display 672. The displays are selectable to show additional details about the selected product.

FIG. 19 is a screen shot of an example item details page 690 provided by the centralized store interface engine 620. This item details page 690 is provided after selection of the summary display 680, for example, from the home page 640 (FIG. 18).

In this example, the item details page 690 includes the toolbar 642, and an item details display 692. Additional information can also be obtained by selecting the payment control 694 for additional payment information, ask question control 696 to submit a question to the seller, and other items control 698 to view other items that for sale by the seller.

In this example, the item details display 692 includes an image 702 of the product (if provided), product information (such as quantity, category, location, time left, start time, end time, price, etc.), a buy out control 706, seller information 708, a product description 710, product image listing 712 and display 714, and shipping information 716.

In some embodiments, products can be sold by an auction process, a sale process, or a combination. For an auction, an ending date and time is assigned to the product, and customers are permitted to bid on the product. A minimum price can also be assigned. The customer with the highest bid (that exceeds the minimum bid) at the end time wins the auction. For a sale, a price is assigned to the product and any customer can purchase the product at any time for that price (such as initiated using the buy out control 706). A combination includes a sale price for which the product can be purchased at any time, and an end time, at which a highest bidder wins the auction if no customer has agreed to pay the sale price.

FIG. 20 is a screen shot of an example customized repair site home page 720, such as generated by the customized repair site store interface engine 622. The customized repair site home page 720 includes a products display window 722 including a customized header 724, and product displays 730, 732, 734, 736, and 738.

The home page 720 is similar to home page 640 (shown in FIG. 18), but the home page 720 includes only those products that are for sale by a particular repair site 108 (such as the first repair site, discussed herein). In addition, the home page 720 is customized (sometimes alternatively known as a custom labeling or skinning) to have the appearance of, and function as, a custom store front for the repair site 108. In this example, the customization includes a customized header 724 that includes a repair site custom banner 726, and repair site advertisements 728.

The repair site custom banner 726 typically includes the name of the repair site 108 and the company logo. Additional information can also be included, such as contact information (a telephone number, web site URL, or e-mail address, for example). The customized header 724 is prominently displayed at or near the top of the home page 720 to identify the page as belonging to the particular repair site 108.

The repair site advertisements 728 are advertisements that are configured by the retail site. In some embodiments, the retail site charges a fee for the display of advertisements of third party businesses on the home page 720. The fee can be used to offset subscription costs for the use of the store engine 224, for example, or to provide revenue to the repair site 108.

Products available for purchase from the repair site 108 are displayed in the products display window 722. In this example, the product display window includes featured products display 730, recently listed products display 732, ending soon products display 734, wanted ads display 736, and general product listing displays 738. Within these displays, information about the products is shown in a summary display 740. Upon selection of a product, an item details page is displayed, such as shown in FIG. 19. However, the item details page can include the customized header 724 or other repair site customization, in some embodiments.

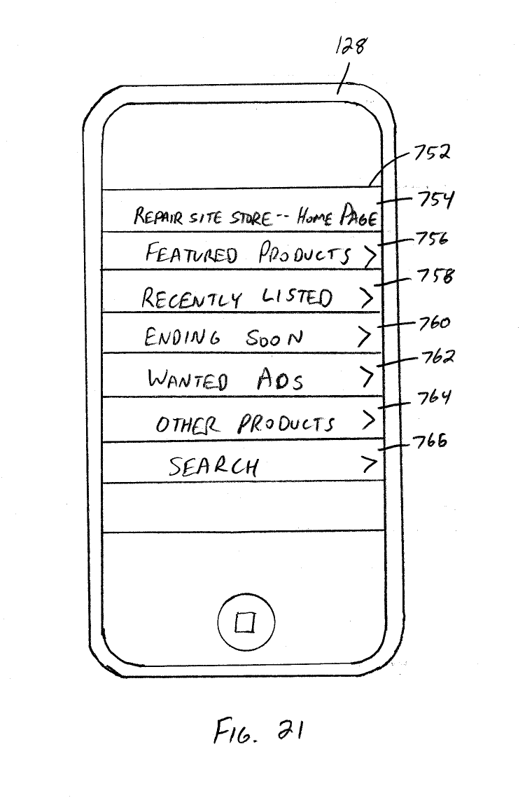

FIGS. 21-23 illustrate the operation of the store engine 224 with a mobile computing device 128. The pages generated by the store engine 224 can be provided in a mobile form, in which the pages are modified for use with mobile computing device 128. Several examples are illustrated with reference to FIGS. 21-23. Additional pages can also be included.

FIG. 21 is a screen shot of a mobile home page 752 provided by the customized repair site store interface engine 622 and displayed on a mobile computing device 128. The mobile home page 752 displays some of the same information as displayed in the example home page 720, shown in FIG. 20, but in a different format. Additional information is displayed after receipt of a selection of one of the selectable controls.

In this example, the mobile home page 752 includes custom banner 754, featured products control 756, recently listed control 758, ending soon control 760, wanted ads control 762, other products control 764, and search control 766.

The custom banner 754 typically includes at least a name of the repair site, and may also include a logo or other information about the repair site.

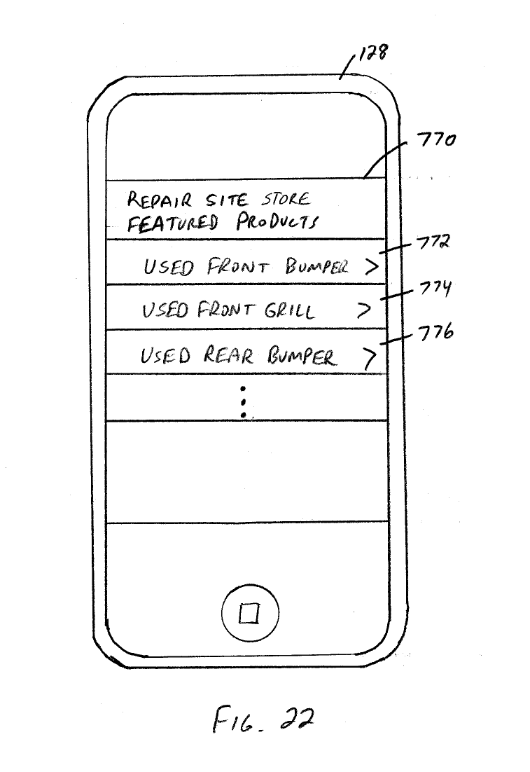

The controls 756, 758, 760, 762, and 764 are all selectable to display a product listing page including a list of associated products, such as shown in FIG. 22.

The search control 766 operates to display a search interface page for conducting a search query in a similar manner to the search control 664 (FIG. 18) described herein.

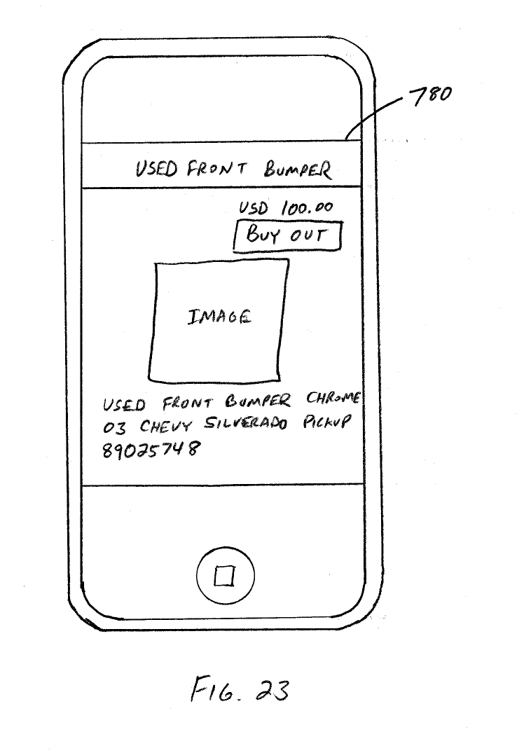

FIG. 22 is a screen shot of an example featured products page 770 displayed on a mobile computing device 128. The featured products page 770 includes a list of the featured products. The list includes summary displays 772, 774, and 776 for each product, which is selectable to cause the display of an item details page, as shown in FIG. 23.

FIG. 23 is a screen shot of an example item details page 780 displayed on a mobile computing device 128. The item details page 780 displays information about the product, such as a price, an image, and a description. Additional information can also be displayed, such as any of the item details shown in FIG. 19.

FIGS. 24-27 illustrate the operation of an example jobs engine 226 (shown in FIG. 3).

FIG. 24 is a screen shot of an example jobs home page 790. The jobs home page includes job listing displays including latest listings display 792, auto body collision display 794, collision body display 796, and collision repair ship display 798. Each of the displays includes a listing of jobs associated with the display category. Some embodiments further include a search control 800, and filter controls 802.

The search control 800 is provided to receive a search query from a user, and to perform a search for job postings that match the search query. The results are displayed in a search results listing.

The filter controls 802 are selectable to filter the job postings, so that only those job postings that match the associated filter are included in the job listing. For example, the filter controls include part time, full time, and freelance filters.

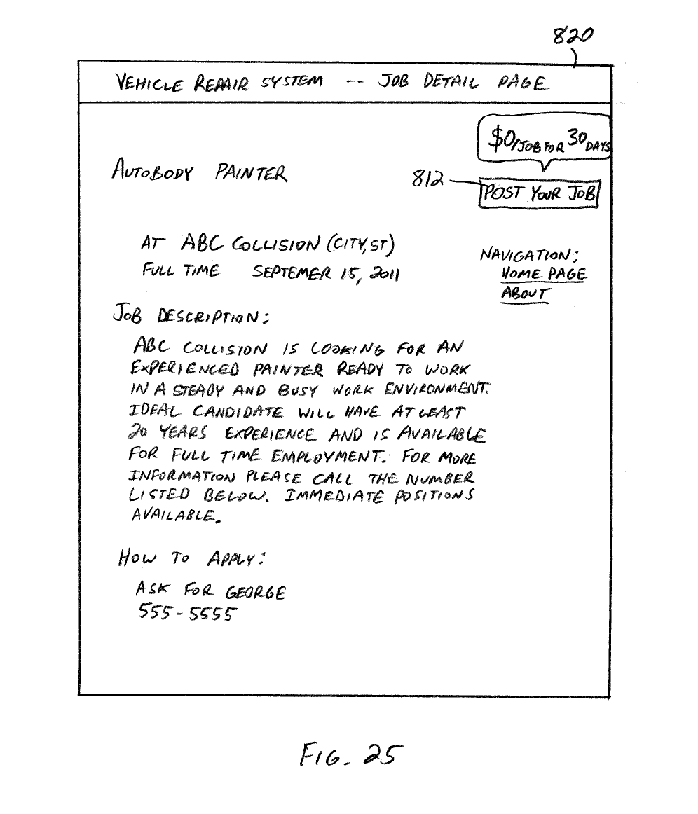

The latest listings display includes a list of the most recent job postings. Each job posting is represented by a summary display 804, 806, 808, and 810. The summary displays provide information about the job, such as a title, a type (full time, part time, or freelance), a company that the job is with, a location of the job, and the date that the job was posted. The summary displays are selectable, and upon selection, the associated job detail page is displayed, such as shown in FIG. 25.

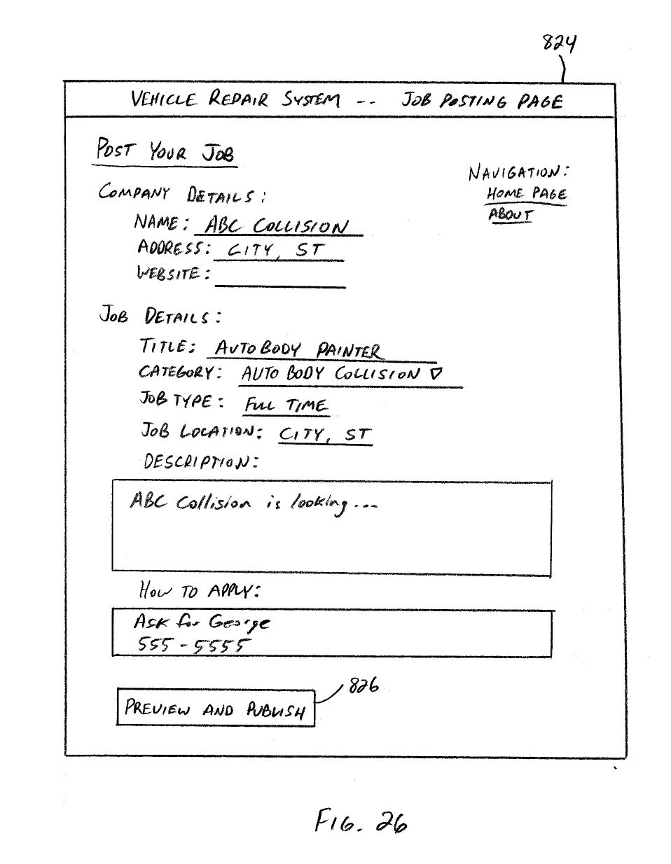

A post your job control 812 is selectable by a user to initiate the creation of a new job posting. After selection, the job posting page 824, such as shown in FIG. 26, is displayed to receive the job information from the user.

FIG. 25 is a screen shot of an example job detail page 820. The job detail page provides additional information about the job. In this example, the job detail page 820 is provided after a user has selected the summary display 804, shown in FIG. 24.

The job detail page 820 includes additional information about the job, such as the title, company, type, posting date, job description, and instructions for applying.

The post your job control 812 can be selected to navigate to the job posting page 824, shown in FIG. 26.

FIG. 26 is a screen shot of an example job posting page 824. In one example, the job posting page 824 is displayed to the repair site user 134 on the repair site computing device 132, so that the repair site user can enter information about a job that is available at the repair site.

The job posting page 824 prompts the user to enter information about the job that is available. In this example, the job posting page 824 prompts the user for company details and job details. The company details include, for example, the name, address, and website for the company. The job details include, for example, the title, category, type, location, and description of the job. Instructions for how to apply are also provided. Once entered, the jobs information is stored in jobs data 236, shown in FIG. 3. The jobs engine 226 can subsequently retrieve the jobs information from the jobs data and use the information to generate the pages such as shown in FIGS. 24-25.

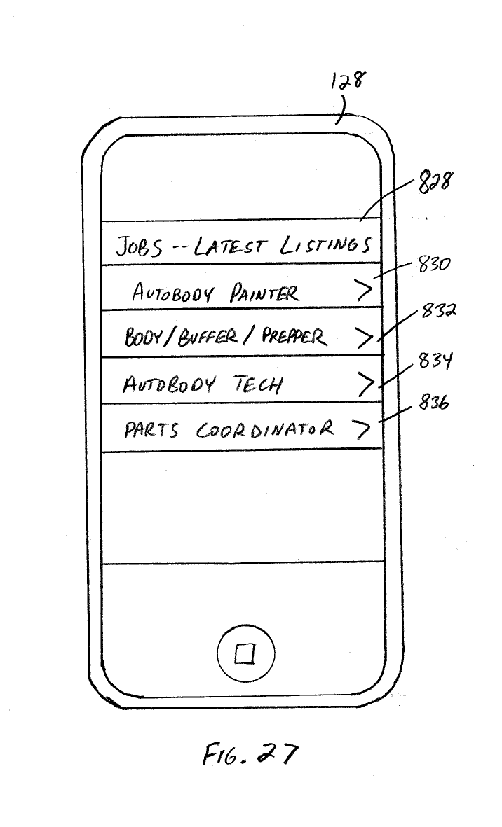

FIG. 27 illustrates the operation of an example jobs engine 226 interacting with a mobile computing device 128. FIG. 27 is a screen shot of an example mobile latest listings page 828 as displayed on a mobile computing device 128. The mobile latest listings page 828 provides a list of the most recently posted jobs. Each of the jobs is displayed with a summary display 830, 832, 834, and 836 that is selectable to show additional information about the job. Additional mobile pages can be similarly generated and displayed.

The foregoing description makes reference to exemplary implementations in a vehicle repair network 100 (FIG. 1). The systems, devices, methods, operations, and functions disclosed herein can also be implemented in other networks, such as within other industries, businesses, clubs, organizations, educational institutions, and the like.

For example, another embodiment includes a building construction network, including a customer, a construction company user, and insurance company user. The construction company user is associated with a construction company hired to build or remodel a building owned or leased by the customer. The building construction network includes a building construction system, including a server and a data storage device. The building construction system includes a status engine, store engine, and jobs engine. The status engine tracks the status of the building construction or remodeling. The store engine provides a marketplace for selling products associated with building construction. The jobs engine provides a jobs board for posting jobs relating to building construction. Accordingly, the building construction system can be used in a similar manner to the vehicle repair system 102 described herein, but within a different industry.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of obtaining customer authorization for a vehicle repair, the method comprising:
storing, with a computing device, a supplemental estimate document in a data storage device, the supplemental estimate describing a supplemental repair for which customer approval has not been obtained;
generating and sending a supplemental repair message to the customer informing the customer of a need for the supplemental repair; and
receiving an authorization message from the customer authorizing the supplemental repair.

2. The method of claim 1, wherein the authorization message is an e-mail from the customer.

3. The method of claim 2, wherein the e-mail includes a digital signature and a driver's license number.

4. The method of claim 1, wherein the authorization message is an e-mail that includes a date and time of transmission, and identifies the supplemental estimate, wherein the supplemental estimate includes a description of additional repairs, parts, labor, and total additional cost.

5. The method of claim 1, further comprising proceeding with the supplemental repair only after receiving the e-mail.

6. The method of claim 1, further comprising generating a customer interface page including a summary display of a repair order associated with the vehicle repair, the summary display including a graphical element that graphically indicates that the repair order is on hold awaiting authorization of a supplemental repair.

7. The method of claim 1, wherein the graphical element is selectable, and upon selection of the graphical element, providing the supplemental repair message to the customer.

8. The method of claim 7, wherein the supplemental repair message includes a picture showing an aspect of the supplemental repair.

9. The method of claim 7, wherein the supplemental repair message is displayed by a customer mobile computing device.

10. The method of claim 7, further comprising receiving a selection of an authorization control indicating that the customer has received the estimate identifying labor costs, part costs, and a total cost and that the customer agrees to the supplemental repair.

11. The method of claim 6, wherein the summary display further includes a second graphical element indicating a delay status of the repair order.

12. A system comprising at least one processor device and at least one computer readable storage medium storing data instructions thereon, the system further comprising:
a status engine operable by the at least one processor upon execution of the data instructions to maintain a record of a project at a company and to provide status information from the record to customers of the company showing the statuses of the projects;
a store engine operable to generate a marketplace for sales of products associated with the company, wherein products at the company are listed for sale by the store engine and products needed by the company are available for purchase through the store engine; and
a jobs engine providing a jobs board that receives job information from the company and transmits that information to prospective employees of the company.

13. A vehicle repair system, the vehicle repair system comprising at least one processor device and at least one computer readable storage medium storing data instructions thereon, the vehicle repair system further comprising:
a status engine operable by the at least one processor upon execution of the data instructions to maintain a record of vehicle repairs at a vehicle repair site and to provide status information from the record to customers of the vehicle repair site showing the statuses of the vehicle repairs;
a store engine operable to generate a marketplace for sales of products associated with vehicle repairs, wherein products at the vehicle repair site are listed for sale by the store engine and products needed by the vehicle repair site are available for purchase through the store engine; and
a jobs engine providing a jobs board that receives job information from the vehicle repair site and transmits that information to prospective employees of the vehicle repair site.

14. The vehicle repair system of claim 13, wherein the status engine includes a customer interface engine configured to interact with a customer, a repair site interface engine configured to interact with a repair site user, an insurance company interface engine configured to interact with an insurance company user, and a rental car company interface engine configured to interact with a rental car company user.

15. The vehicle repair system of claim 13, wherein the store engine includes a centralized store interface engine, a first customized repair site store interface engine associated with the vehicle repair site, and a second customized repair site store interface engine associated with a second vehicle repair site, wherein the centralized store interface engine generates a store interface through which products can be purchased from both of the vehicle repair site and the second vehicle repair site.

16. The vehicle repair system of claim 13, wherein the store engine receives product information from a vehicle repair site user describing a product to be sold, and wherein the store engine prompts the user to select whether the product should be sold by auction, by sale, or by a combination auction/sale.

17. The vehicle repair system of claim 13, wherein the store engine further generates a want ad identifying one or more products needed by the vehicle repair site.

18. A vehicle repair system comprising at least one processing device and at least one computer readable storage media, the at least one computer readable storage media storing program instructions that when executed by the at least one processing device generate:
a status engine operable by the at least one processing device to receive status information from one or more vehicle repair site users describing a status of a vehicle being repaired at the vehicle repair site, and to provide the status information to a customer associated with the vehicle, wherein the status information is provided through one or more web pages, at least one of the web pages including a summary status display, wherein the summary status display identifies at least a delay status and a supplemental repair status, wherein the delay status identifies whether the repair is currently delayed, and wherein the supplemental repair status identifies whether any additional work has been identified for which the customer's approval is required.

19. The vehicle repair system of claim 18, wherein the summary status display is selectable to initiate a supplemental repair authorization process.

20. The vehicle repair system of claim 18, wherein the status engine is operable to perform the supplemental repair authorization process with a customer through a mobile computing device to receive authorization of a supplemental repair from the customer.
